(19) United States
(12) Patent Application Publication
(10) Pub. No.: US 2026/0149173 A1
(43) Pub. Date: May 28, 2026

(54) SPIRAL LAYOUT FOR SCALABLE LOW-SIDELOBE PHASE ARRAYS AND ON-CHIP SPATIAL LIGHT MODULATOR-ASSISTED SPIRAL OPTICAL PHASED ARRAY

(71) Applicant: Technology Innovation Institute - Sole Proprietorship LLC, Khalifa City, Abu Dhabi (AE)

(72) Inventors: Nikita Kondratyev, Abu Dhabi (AE); Marcus Engsig, Abu Dhabi (AE); Evgeny Lonshakov, Abu Dhabi (AE); Faheem Ahmad, Abu Dhabi (AE); Ramzil Galiev, Abu Dhabi (AE); Mahmoud Gaafar, Abu Dhabi (AE); Ravikiran Saripalli, Abu Dhabi (AE)

(73) Assignee: Technology Innovation Institute - Sole Proprietorship LLC, Khalifa City, Abu Dhabi (AE)

(21) Appl. No.: 19/390,853

(22) Filed: Nov. 17, 2025

Related U.S. Application Data
(60) Provisional application No. 63/725,638, filed on Nov. 27, 2024.

(51) Int. Cl. H01Q 3/26; H01Q 1/36; H04B 7/0426

(52) U.S. Cl. CPC H01Q 3/2658; H01Q 1/36; H04B 7/043

(57) ABSTRACT

A phased array antenna system, comprising a substrate, an energy source or an energy detector, and a plurality of antenna elements arranged in a spiral pattern on the substrate and coupled to the energy source configured to transmit energy from the antenna elements or coupled to the energy detector configured to receive energy via the antenna elements, the spiral pattern defined based on optimization of parameters defining physical placement of the antenna elements relative to one another on the spiral pattern and relative to a center of the spiral pattern to minimize sidelobes of an interference pattern produced the transmitted energy or received energy via the antenna elements.

### CROSS-REFERENCE TO RELATED APPLICATIONS

This application claims priority to U.S. Provisional Patent Application No. 63/725,638, filed Nov. 27, 2024, which is incorporated by reference in its entirety.

### FIELD

The present disclosure generally relates to a system and method for spiral layout for scalable low-sidelobe phase arrays and on-chip spatial light modulator-assisted spiral optical phased array. The system and method may provide phased array antenna systems including a plurality of antenna elements arranged in a spiral pattern on a substrate. The spiral pattern may be defined based on setting parameters that determine the physical placement of the antenna elements relative to one another and relative to the center of the spiral pattern.

### BACKGROUND

Phased array antenna systems have become increasingly important in various applications. These systems typically include multiple antenna elements arranged in a specific pattern, allowing for electronic beam steering and shaping without mechanical movement. Traditional phased array designs often utilize uniform rectangular or square lattice arrangements of antenna elements. In optical phased arrays, the antenna elements are typically optical emitters or receivers integrated onto a photonic chip. Recent advancements have explored non-uniform and aperiodic array configurations, such as spiral patterns, to improve performance characteristics like sidelobe suppression and beam forming capabilities.

However, existing phased array antenna systems face several challenges. Uniform arrays suffer from aliasing issues when element spacing exceeds half a wavelength, which is often impractical in optical systems. Non-uniform arrays, while promising, often struggle to achieve improved sidelobe suppression across a wide range of operating conditions. Additionally, the complexity of power routing and phase control in densely packed arrays can lead to increased system complexity, power consumption, and cost. Furthermore, achieving precise phase control for each antenna element, particularly in optical systems, remains a significant technical hurdle. These limitations hinder the widespread adoption and performance of phased array antenna systems in emerging applications such as LiDAR, free-space optical communication, and advanced sensing technologies.

### SUMMARY

In one aspect, the present disclosure relates to a phased array antenna system, comprising a substrate, an energy source or an energy detector, and a plurality of antenna elements arranged in a spiral pattern on the substrate and coupled to the energy source configured to transmit energy from the antenna elements or coupled to the energy detector configured to receive energy via the antenna elements, the spiral pattern based on parameters defining physical placement of the antenna elements relative to one another on the spiral pattern and relative to a center of the spiral pattern to minimize sidelobes of an interference pattern produced the transmitted energy or received energy via the antenna elements.

In embodiments of this aspect, the disclosure according to any one of the above example embodiments, the parameters defining the physical placement of the antenna elements may comprise a spiral power parameter defining how tightly the spiral is wound, an angular step parameter defining an angle between consecutive antenna elements, and a spiral start parameter defining a starting point of the spiral.

In embodiments of this aspect, the disclosure according to any one of the above example embodiments, wherein the spiral power parameter, the angular step parameter and the spiral start parameter are set in relation to one another to produce the spiral pattern that minimizes the sidelobes of the interference pattern.

In embodiments of this aspect, the disclosure according to any one of the above example embodiments, further comprising waveguides extending from the antenna elements, the waveguides coupled to the energy source or the energy detector, the waveguides extending from the antenna elements at an angle perpendicular to the substrate.

In embodiments of this aspect, the disclosure according to any one of the above example embodiments, the antenna elements are at least one of optical emitters, acoustic emitters, radio frequency emitters, optical receivers, acoustic receivers, radio frequency receivers.

In embodiments of this aspect, the disclosure according to any one of the above example embodiments, further comprising a spiral waveguide extending from the energy source or the energy detector and evanescently coupled to the antenna elements.

In embodiments of this aspect, the disclosure according to any one of the above example embodiments, further comprising radial waveguides extending from the antenna elements, the radial waveguides coupled to the energy source or the energy detector.

In embodiments of this aspect, the disclosure according to any one of the above example embodiments, wherein setting the parameters comprises a defined search space for the parameters, and iterative adjustment of the parameter to improve minimization of the sidelobes.

In one aspect, the present disclosure relates to a phased array antenna system for an optical array, comprising a substrate, a light source or a light detector, a plurality of optical antenna elements arranged in a spiral pattern on the substrate and coupled to the light source configured to transmit light from the antenna elements or coupled to the light detector configured to receive light via the antenna elements, the spiral pattern based on parameters defining physical placement of the antenna elements relative to one another on the spiral pattern and relative to a center of the spiral pattern to minimize sidelobes of an interference pattern produced the transmitted light or received light via the antenna elements, and a spatial light modulator positioned to receive and modulate light emitted from the plurality of optical antenna elements or received by the phased array antenna system to perform beam steering.

In embodiments of this aspect, the disclosure according to any one of the above example embodiments, the parameters defining the physical placement of the optical antenna elements may comprise a spiral power parameter defining how tightly the spiral is wound, an angular step parameter defining an angle between consecutive optical antenna elements, and a spiral start parameter defining a starting point of the spiral.

In embodiments of this aspect, the disclosure according to any one of the above example embodiments, wherein the spiral power parameter, the angular step parameter and the spiral start parameter are set in relation to one another to produce the spiral pattern that minimizes the sidelobes of the interference pattern.

In embodiments of this aspect, the disclosure according to any one of the above example embodiments, further comprising waveguides extending from the antenna elements, the waveguides coupled to the light source or the light detector, the waveguides extending from the antenna elements at an angle perpendicular to the substrate.

In embodiments of this aspect, the disclosure according to any one of the above example embodiments, further comprising a spiral waveguide extending from the light source or the light detector and evanescently coupled to the optical antenna elements.

In embodiments of this aspect, the disclosure according to any one of the above example embodiments, further comprising radial waveguides extending from the antenna elements, the waveguides coupled to the light source or the light detector.

In embodiments of this aspect, the disclosure according to any one of the above example embodiments, wherein setting the parameters comprises defining a search space for the parameters, and iterative adjustment of the parameters to improve minimization of the sidelobes.

In embodiments of this aspect, the disclosure according to any one of the above example embodiments, further comprising a controller configured to control the spatial light modulator to adjust phase shifts of light emitted from the optical antenna elements.

In embodiments of this aspect, the disclosure according to any one of the above example embodiments, the controller is configured to determine the phase shifts for each of the optical antenna elements based on a desired beam direction.

In embodiments of this aspect, the disclosure according to any one of the above example embodiments, the controller is configured to map each of the optical antenna elements to corresponding pixels of the spatial light modulator.

In embodiments of this aspect, the disclosure according to any one of the above example embodiments, the controller is configured to dynamically update the spatial light modulator configuration to change a desired beam direction for scanning or tracking applications.

In embodiments of this aspect, the disclosure according to any one of the above example embodiments, the controller is configured to monitor beam quality of a formed beam, comprising assessing sidelobe suppression and main lobe direction, adjust the spatial light modulator configuration based on the monitored beam quality, and compensate for environmental factors by fine-tuning the spatial light modulator configuration.

In embodiments of this aspect, the disclosure according to any one of the above example embodiments, further comprising a microlens array positioned to receive light modulated by the spatial light modulator.

In embodiments of this aspect, the disclosure according to any one of the above example embodiments, the spatial light modulator comprises a transmissive liquid crystal on silicon device.

### BRIEF DESCRIPTION OF THE DRAWINGS

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1A illustrates a schematic view of a phased array antenna transmitter in operation, according to aspects of the present disclosure.

FIG. 1B illustrates a block diagram of a phased array antenna transmitter and receiver system, according to aspects of the present disclosure.

FIG. 2A illustrates a top orthogonal view of a rectangular spaced antenna element array, according to aspects of the present disclosure.

FIGS. 2B-2D illustrate graphs showing emission patterns of square phased array antennas with different inter-antenna element distance, according to aspects of the present disclosure.

FIG. 3A illustrates a top view of a spiral array for a phased array antenna system, according to aspects of the present disclosure.

FIGS. 3B-3G illustrate various spiral antenna element patterns for a phased array antenna system, according to aspects of the present disclosure.

FIG. 4A illustrates a flowchart for a method of fabricating a phased array antenna system, according to an aspect of the present disclosure.

FIG. 4B illustrates a flowchart for a method of setting parameters for a spiral antenna array, according to aspects of the present disclosure.

FIGS. 5A-5B illustrate graphs showing minimum inter-element distance for different spiral array configurations, according to aspects of the present disclosure.

FIGS. 5C-5D illustrate scaling diagrams of a Fermat spiral antenna, according to aspects of the present disclosure.

FIGS. 5E-5F illustrate graphs showing SLL performance of Vogel and square spiral arrays, according to aspects of the present disclosure.

FIGS. 5G-5H illustrate graphs related to spiral antenna array performance, according to aspects of the present disclosure.

FIGS. 51-5J illustrate graphs related to a spiral antenna array performance and configuration, according to aspects of the present disclosure.

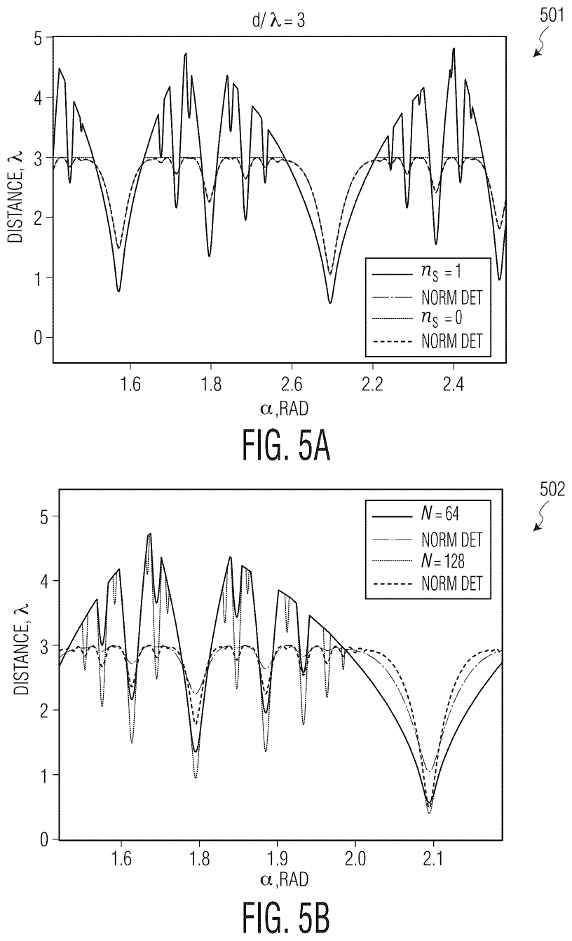

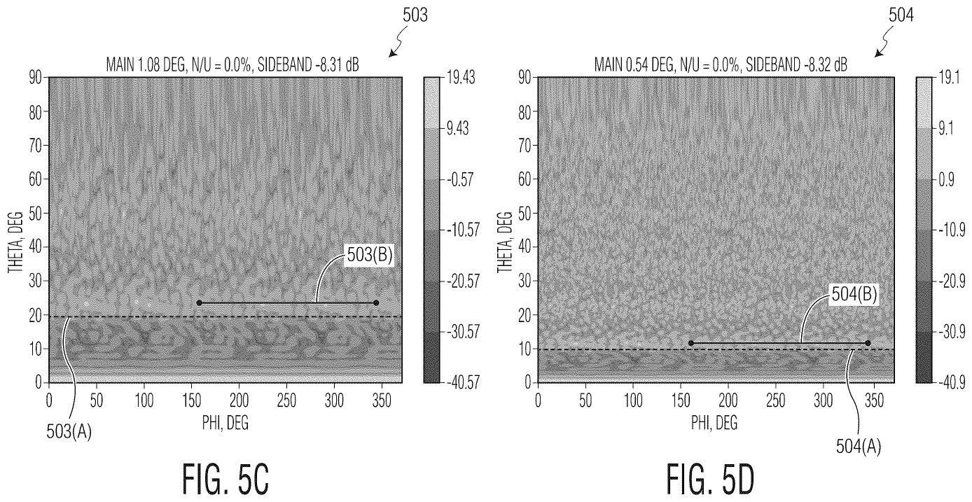

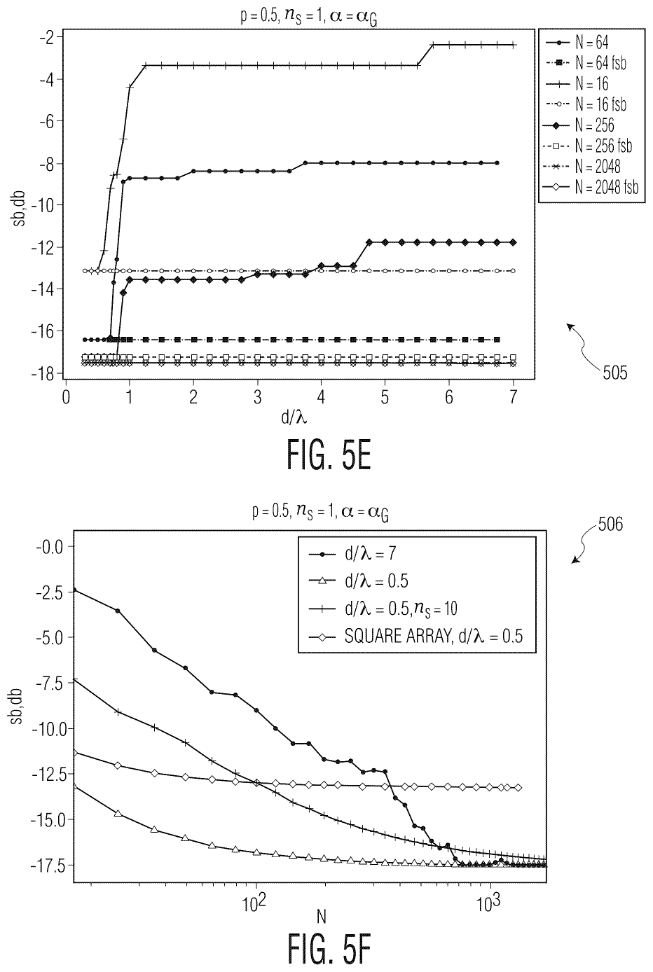

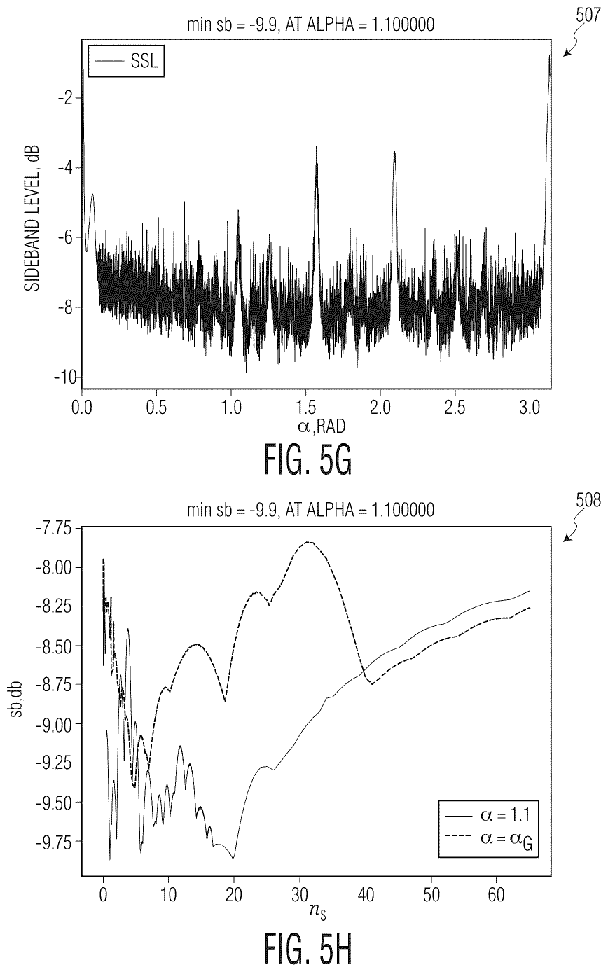

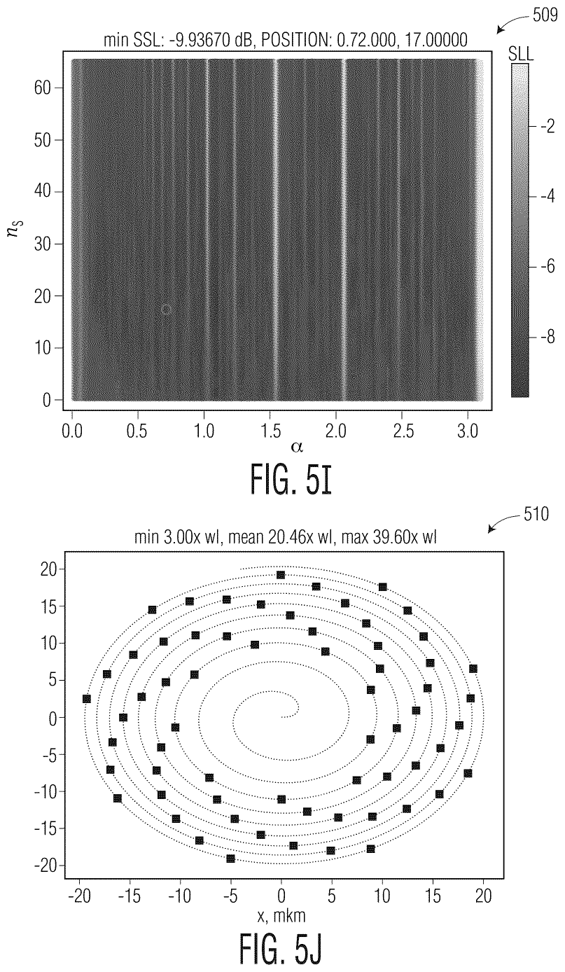

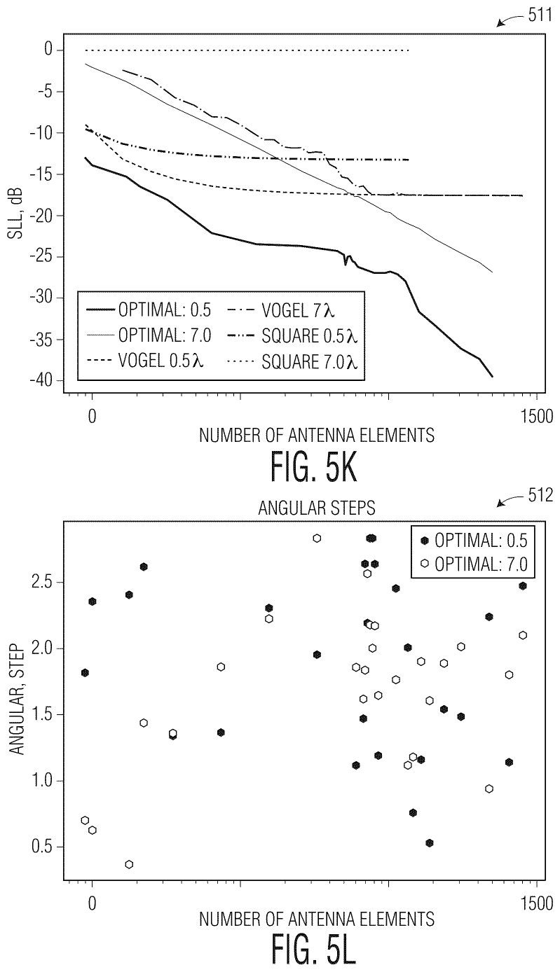

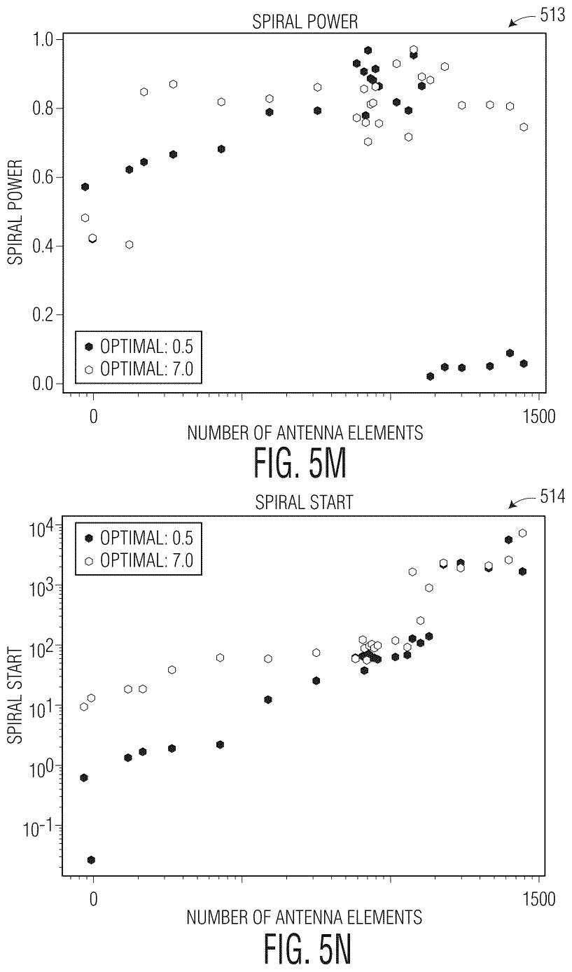

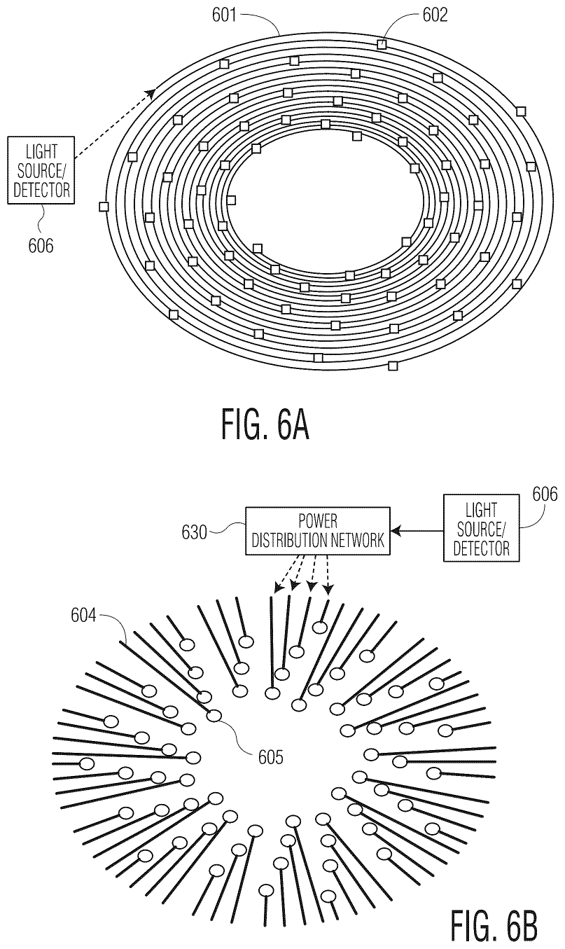

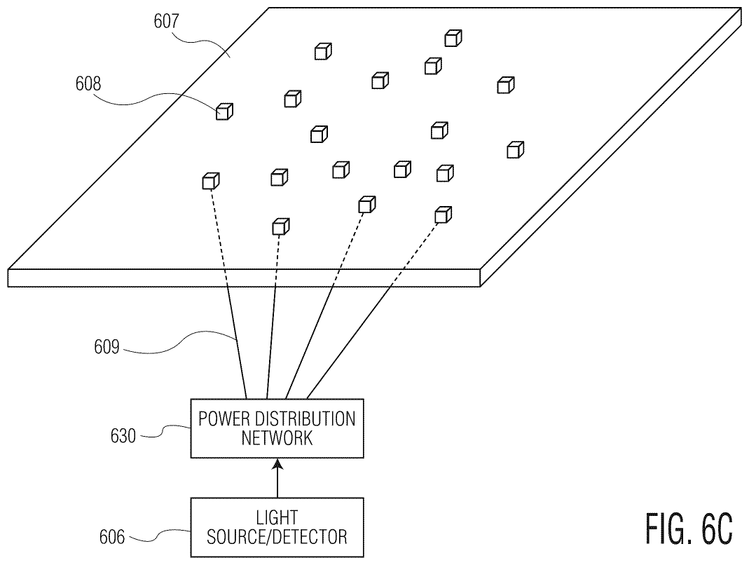

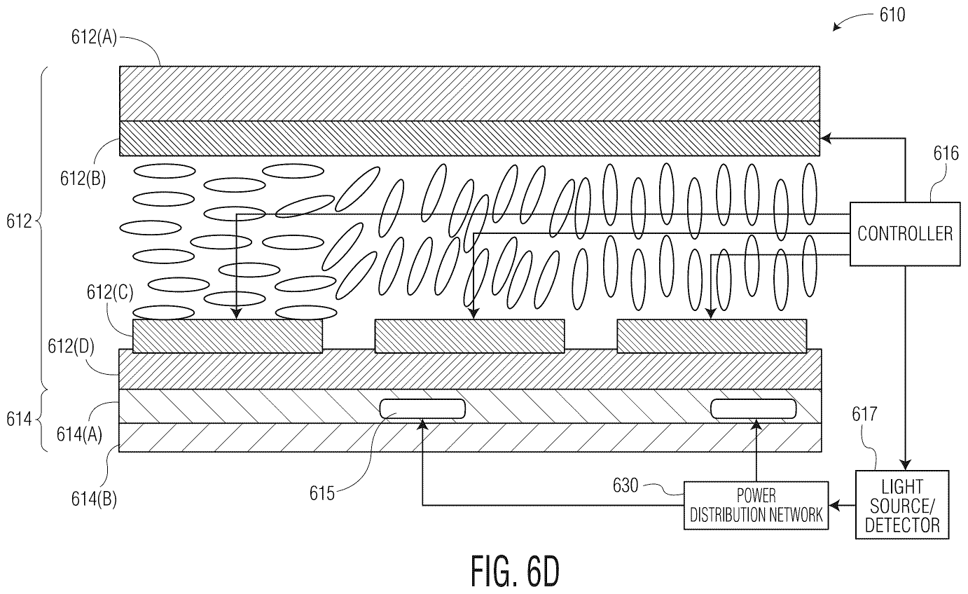

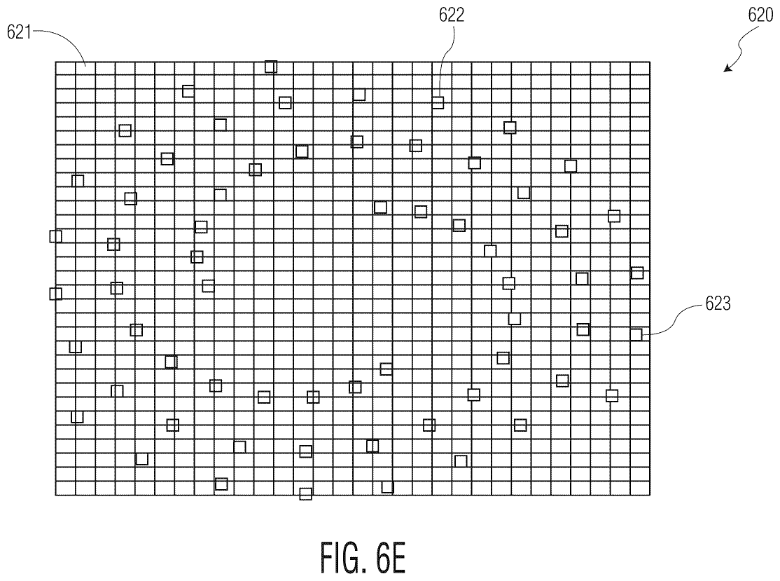

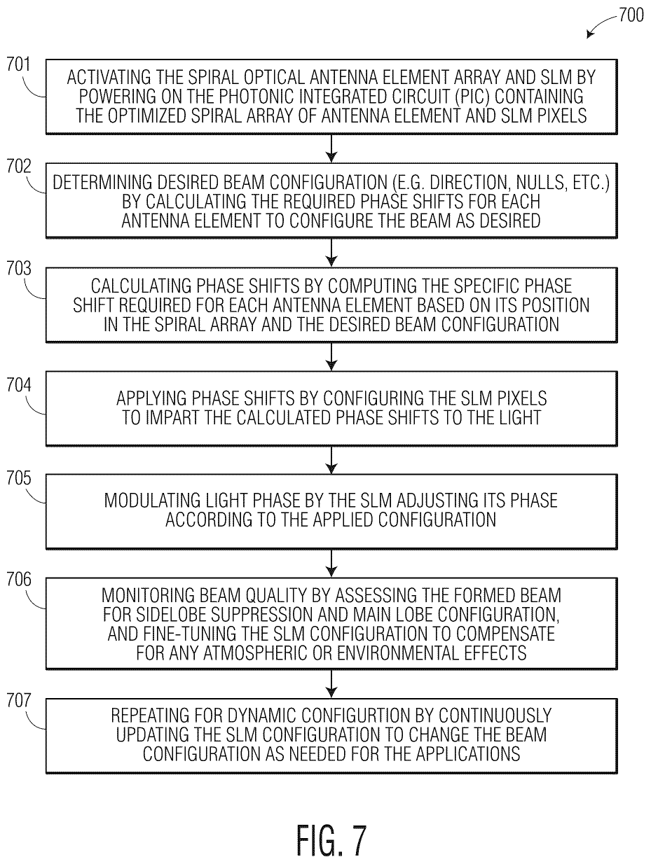

FIG. 5K illustrates a comparison of a spiral SLL for different antenna array configurations, according to aspects of the present disclosure.

FIGS. 5L-5N illustrate graphs showing setting spiral array parameters for different numbers of antenna elements, according to aspects of the present disclosure.

FIGS. 6A-6B illustrate two waveguide configurations of a phased array antenna system for optical applications, according to aspects of the present disclosure.

FIG. 6C illustrates a three-dimensional view of a phased array antenna system with optical fibers for optical applications, according to aspects of the present disclosure.

FIG. 6D illustrates a block diagram of a system comprising a SLM on top of phased array antenna, according to an aspect of the present disclosure.

FIG. 6E illustrates a top view of a spatial light modulator for use in a phased array antenna system, according to aspects of the present disclosure.

FIG. 7 illustrates a flowchart for a method of operating a phased array antenna system with a spatial light modulator, according to aspects of the present disclosure.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

The present disclosure relates to phased array antenna systems and methods for setting physical placement of antenna element arrangements relative to one another to improve performance characteristics such as sidelobe suppression and beam steering capabilities. In particular, the disclosure provides phased array antenna systems including a plurality of antenna elements arranged in an improved spiral pattern on a substrate. The spiral pattern may be defined based on setting parameters that determine the physical placement of the antenna elements relative to one another and relative to the center of the spiral pattern. For example, a spiral power parameter defining how tightly the spiral is wound, an angular step parameter defining an angle between consecutive antenna elements, and a spiral start parameter defining a starting point of the spiral may are set in relation to one another to produce the improved spiral pattern that achieves a desired goal such as reducing (e.g. minimizing) sidelobes in the interference pattern produced by the transmitted or received energy via the antenna elements. These parameters may be adjusted to also achieve other performance objectives such as main lobe directivity, beam width control, control of the array's overall size and element density, which may be beneficial for applications with specific form factor constraints, and creation of null regions in the radiation pattern, which can be useful for interference suppression in certain directions. The flexibility afforded by this parametric approach to spiral array design may enable the creation of antenna systems that can be tailored to meet a wide range of performance criteria beyond sidelobe reduction alone. It is noted that in examples, the process of setting the parameters to produce the improved spiral pattern may include optimization algorithms.

In aspects, the phased array antenna system may include an energy source or an energy detector coupled to the antenna elements. The antenna elements may be configured to transmit energy from the energy source or receive energy via the energy detector. The energy may include, but is not limited to, electromagnetic energy such as radio frequency or optical energy, or acoustic energy. The antenna elements may take many forms such as optical emitters, acoustic emitters, radio frequency emitters, optical receivers, acoustic receivers, radio frequency receivers or the like. The antenna elements may include various structures, for example, such as grating couplers and plasmonic antennas for optical applications. The antenna elements may comprise other types of antennas, mirrors, lenses, or directive structures suitable for electromagnetic or acoustic waves. The specific type and configuration of the antenna elements may be selected based on the intended application and operating frequency of the phased array antenna system.

In an example, setting the parameters to achieve a desired goal such as reducing (e.g. minimizing) sidelobes in the interference pattern may include an optimization of the spiral pattern by setting parameters such as a spiral power parameter, an angular step parameter, and a spiral start parameter to optimal values. As mentioned above, these parameters may define how tightly the spiral is wound, the angle between consecutive antenna elements, and the starting point of the spiral, respectively. In implementations, the optimization may be performed using algorithms such as particle swarm optimization. In aspects, other optimization techniques such as genetic algorithms, simulated annealing, or gradient descent methods may be employed to determine the improved spiral pattern for the antenna elements.

For optical applications, the phased array antenna system may further include a spatial light modulator (SLM) positioned to receive and modulate light emitted from or received by the antenna elements. This configuration may enable beam steering capabilities for applications such as light detection and ranging (LiDAR), free-space optical communications, and advanced sensing technologies.

The disclosed phased array antenna systems may offer several potential benefits. The spiral arrangement of antenna elements may provide improved sidelobe suppression compared to traditional uniform array configurations. This may result in reduced interference and improved signal quality in various applications. The spiral arrangement may also allow for more compact designs, potentially reducing the overall size and complexity of the antenna system.

Additionally, the use of an SLM in optical implementations may provide precise and dynamic control over beam steering without the need for mechanical components. This may enable rapid and accurate beam direction changes for applications requiring high-speed scanning or tracking.

The phased array antenna systems described herein may find applications in a wide range of fields. In telecommunications, these systems may be used for improved wireless communications, including 5G and future generation networks. In automotive and aerospace and marine industries, the systems may be employed in advanced radar, sonar and LiDAR systems for autonomous vehicles and collision avoidance systems. The optical implementations may be particularly useful in free-space optical communications, enabling high-bandwidth data transmission over long distances.

In the field of remote sensing and imaging, the phased array antenna systems may provide enhanced capabilities for environmental monitoring, geological surveys, and medical imaging applications. The improved sidelobe suppression may allow for more accurate and detailed data collection in these fields.

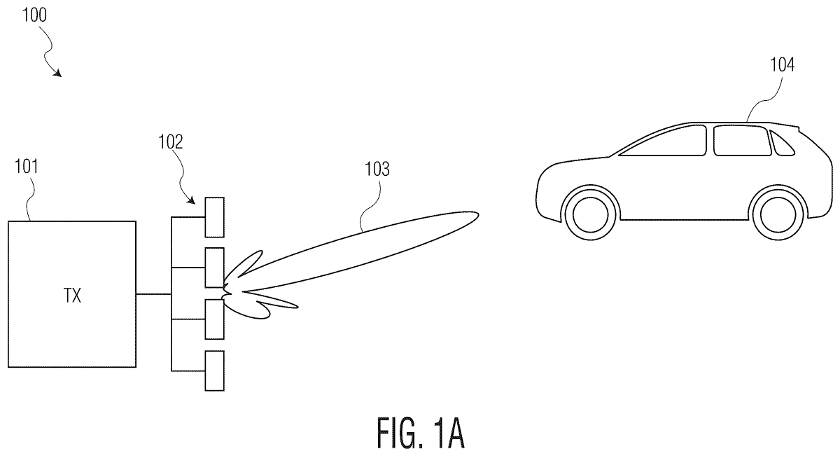

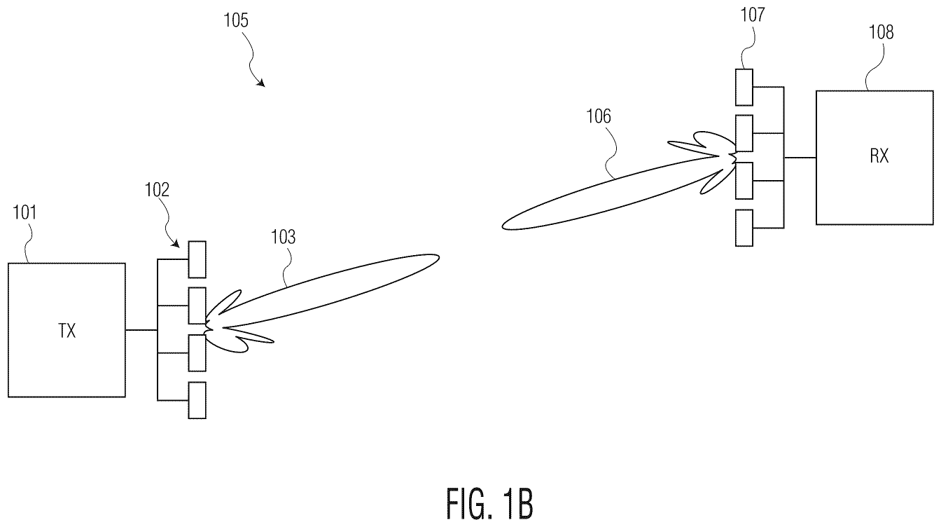

The phased array antenna systems described in this disclosure may be utilized in various applications, some of which are illustrated in FIGS. 1A and 1B. These figures demonstrate the versatility of phased array antenna systems in both transmitting and receiving configurations, highlighting their potential use in diverse fields such as aviation, vehicle networks, telecommunications, and remote sensing.

Specifically, referring to FIG. 1A, a phased array antenna transmitter 100 may be configured to generate and steer a transmission beam pattern 103. The phased array antenna transmitter 100 may include a transmitter 101 connected to transmit antenna array elements 102. In aspects, the transmitter 101 may be configured to generate signals that are provided to the transmit antenna array elements 102. The transmit antenna array elements 102 may be arranged in a vertical array adjacent to the transmitter 101, though other arrangements may be possible.

The transmit antenna array elements 102 may work in concert to shape and direct the transmission beam pattern 103. In cases, the transmission beam pattern 103 may be represented by a conical shape emanating from the transmit antenna array elements 102. The phased array antenna transmitter 100 may be configured to steer the transmission beam pattern 103 towards a desired target, such as a vehicle 104.

In aspects, the phased array antenna transmitter 100 may utilize phase shifting techniques to control the direction and shape of the transmission beam pattern 103. By adjusting the relative phases of the signals provided to each of the transmit antenna array elements 102, the phased array antenna transmitter 100 may electronically steer the transmission beam pattern 103 without physically moving the antenna array. This electronic steering capability may allow for rapid and precise targeting of the transmission beam pattern 103.

The arrangement of the transmit antenna array elements 102 may vary in different implementations. While FIG. 1A depicts a vertical linear array, other 2-dimensional (2D) configurations such as planar arrays, circular arrays, or spiral arrays may be utilized depending on the specific application requirements. The number of transmit antenna array elements 102 may also vary based on factors such as desired beam width, steering range, and overall system performance.

In cases, the phased array antenna transmitter 100 may be used in applications such as radar systems, sonar systems, wireless communications, or satellite communications. The ability to rapidly steer the transmission beam pattern 103 may be particularly useful in tracking moving targets like the vehicle 104, or in establishing and maintaining communication links with mobile platforms.

Now referring to FIG. 1B, a block diagram of a phased array antenna transmitter and receiver system 105 for bi-directional communication is illustrated. The system 105 may include a transmitter 101 connected to transmit antenna array elements 102. The transmit antenna array elements 102 may generate a transmission beam pattern 103. On the receiving side, the system 105 may include receiving antenna array elements 107 connected to a receiver 108. The receiving antenna array elements 107 may detect an incoming reception beam pattern 106.

In aspects, the transmitter 101 may function as an energy source for the transmit antenna array elements 102. The transmitter 101 may provide signals to the transmit antenna array elements 102, which may then emit energy in the form of the transmission beam pattern 103. The transmission beam pattern 103 may be steered and shaped by controlling the phase and amplitude of the signals provided to each of the transmit antenna array elements 102.

In cases, the receiver 108 may function as an energy detector for the receiving antenna array elements 107. The receiving antenna array elements 107 may detect energy from the incoming reception beam 106 and convert it into signals that are processed by the receiver 108. The reception beam 106 may be steered and shaped by controlling the phase and amplitude of the signals received from each of the receiving antenna array elements 107.

The system 105 may demonstrate the bidirectional nature of the phased array antenna, capable of both transmitting and receiving signals using separate antenna arrays and processing units. In aspects, the transmit antenna array elements 102 and receiving antenna array elements 107 may be arranged in spiral patterns to minimize sidelobes in their respective beam patterns. As mentioned above, designing these improved spiral patterns may involve setting parameters such as spiral power, angular step, and spiral start, which define the physical placement of the antenna elements relative to one another and relative to the center of the spiral pattern.

In cases, the system 105 may be configured to operate in different modes. For example, it may operate in a transmission mode where the transmitter 101 and transmit antenna array elements 102 are active, or in a reception mode where the receiver 108 and receiving antenna array elements 107 are active. Alternatively, the system 105 may operate in a full-duplex mode where both transmission and reception occur simultaneously.

The phased array antenna transmitter and receiver system 105 may be applied in various fields such as telecommunications, radar systems, sonar systems, or wireless communications. In aspects, the system 105 may be used in advanced LiDAR systems for autonomous vehicles, providing high-performance beam steering capabilities for both transmitting and receiving light signals. The spiral arrangement of the antenna elements may allow for improved range, resolution, and interference reduction in such applications.

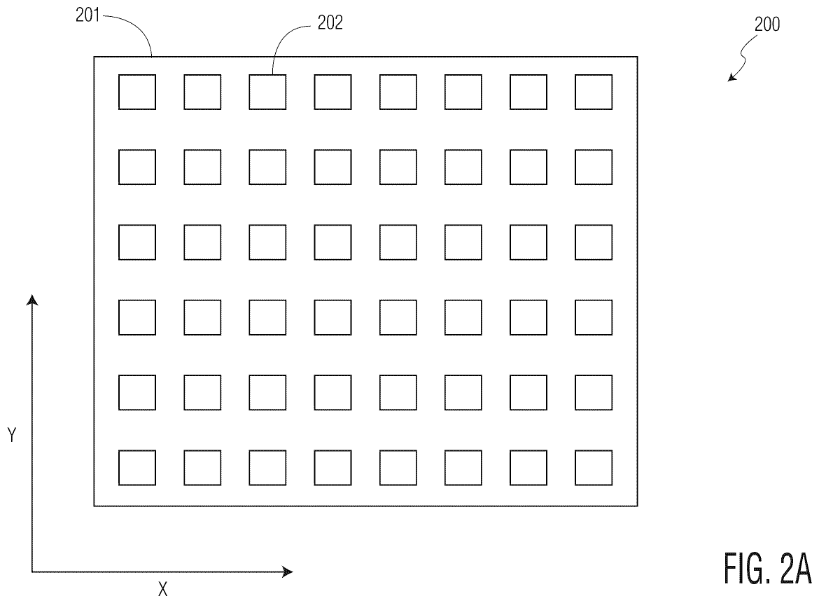

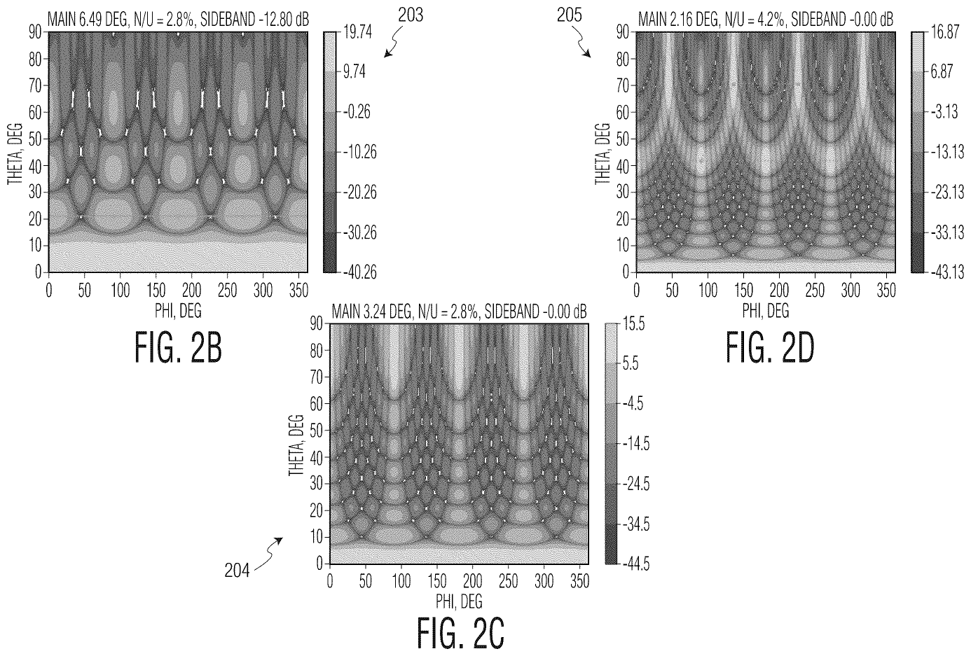

Referring to FIG. 2A, a phased array antenna system 200 may comprise a rectangular substrate 201 with antenna elements 202 arranged in a uniform grid pattern. The antenna element array may include a plurality of antenna elements 202 arranged in a uniform grid pattern on the substrate 201. The substrate 201 may be a rectangular shape, providing a base for the antenna element array. The antenna elements 202 may be arranged in multiple rows and columns forming a matrix structure. Each antenna element 202 may be represented by a square shape, indicating individual addressable elements of the antenna element array.

In this example the array includes 8 columns and 6 rows of antenna elements 202, totaling 48 elements. However, the number of rows and columns may vary depending on the specific application requirements. The antenna element array may be configured to transmit or receive energy via each antenna element 202 independently, allowing for precise control of the wavefront of transmitted or received signals.

The substrate 201 may be made of various materials suitable for antenna applications, such as ceramic, printed circuit board material, or other dielectric materials. The substrate 201 may include additional layers or structures to support the functionality of the antenna elements 202, such as feed networks or ground planes.

The antenna elements 202 may be implemented using various technologies, such as microstrip patches, dipoles, microphones, electroacoustic transducers, or other radiating structures capable of transmitting or receiving energy. The size and spacing of the antenna elements 202 may be set for the intended frequency of operation and the desired beam steering capabilities of the phased array antenna system.

The uniform grid pattern of antenna elements 202 may provide a baseline configuration for comparing performance with more advanced non-uniform array geometries. The regular spacing may allow for straightforward analysis of array factor and grating lobe formation. However, this uniform arrangement may also have limitations in terms of sidelobe suppression and wide-angle scanning that may potentially be addressed by alternative array geometries.

It may be beneficial to review theory for phased array emission. The phased array emission pattern may be calculated using the Huygens-Fresnel principle.

$$\vec{E} ( \vec{r} ) = \sum \frac{1}{\vert {\vec{r}}_{n} - \vec{r} \vert} {\vec{E}}_{n} ( \vec{r} ) {e}^{ik \vert {\vec{r}}_{n} - \vec{r} \vert} , \qquad ( 1 )$$

where \vec{E}(\vec{r}) may represent a diagram of an individual emitter. For simplicity, the emitters may be assumed to be identical. In the far field approximation for the pattern on a sphere with R>>rₙ, the following equation may be obtained:

$$\vec{E} ( θ , ϕ ) = \sum \frac{{e}^{ikR}}{R} \vec{E} ( θ , ϕ ) exp ikd ( sin θ ( {\tilde{x}}_{n} cos ϕ + {\tilde{y}}_{n} sin ϕ ) + {\tilde{z}}_{n} cos θ ) \qquad ( 2 )$$

In this equation, the positions of the emitters may be normalized to a dimensional parameter d (such that \tilde{r}ₙ=\vec{r}ₙ/d), which may represent the array characteristic distance (e.g. the period for a regular grating). From equation (2), it may be observed that the values \tilde{r}ₙ may solely define the form of the array, while the dimensional parameter may be responsible for its scaling. The wavelength and dimensional parameter may enter equation (2) as a ratio, which may allow for the introduction of a dimensionless scaling parameter d/λ=kd/(2π). Features over the elevation angle θ, including the first sideband direction and main peak width, may scale inverse-linearly with this parameter (see also FIGS. 2B-2D). Further analysis may reveal that the number of emitters may also participate in scaling, albeit in a more complex manner to be considered in subsequent sections.

The form of the equation may resemble the discrete Fourier transform, potentially imposing some of its properties on the far field. For a regular (square) array, the periodicity of the structure may lead to aliasing—the emission pattern may become periodical in angular space, potentially giving rise to beams with the same power as the main lobe (aliases). If the period of the grating is smaller than λ/2, the angular distance to the closest alias may be greater than π/2, potentially placing it outside of real space. However, if the inter-emitter distance is increased, the scaling of the emission pattern may be reduced and the aliases may appear in real space (see FIGS. 2B-2D). In cases, if the array is aperiodic, the alias may become far such that sidelobes may appear in the directionality pattern. These sidelobes may be quite intensive, depending on the array form, and may be placed rather irregularly. While scaling—changing the dimensional parameter or the wavelength—may not change the height of the sidebands, it may be challenging to predict at which point it will bring a more powerful sideband from infinity. This may explain the step-wise increase of the sidelobe level (SLL) with array scaling. From another perspective, if the system is optimized for a given scaling parameter d/λ, with a specific wavelength, the SLL may not be worse for higher wavelengths. In other words, the system may be optimized for the lowest desired wavelength of operation.

To illustrate this theory, directivity diagrams 203, 204, and 205 in FIGS. 2B-2D illustrate the emission patterns of phased array similar to the square array in FIG. 2A with different configurations. Specifically, these diagrams show the directivity patterns for a square array of 64 antenna elements with varying ratios of inter-element spacing d to wavelength λ (d/λ).

FIG. 2B, shows directivity diagram 203 representing the emission pattern the square array with d/λ=0.5. The side lobes in this case are the same width and intensity as the main lobe. FIG. 2C shows directivity diagram 204, representing the emission pattern the square array with d/λ=1. The side lobes in this case are narrower but are more intense. FIG. 2D shows directivity diagram 205 representing the emission pattern the square array with d/λ=1.5. The side lobes in this case are narrower but the number of sidelobes are increased.

The progression from FIG. 2B to FIG. 2D demonstrates how increasing the inter-element spacing relative to the wavelength may affect the antenna array's performance. As the spacing increases, the main lobe may become narrower, potentially improving the array's ability to focus energy in a specific direction. However, this improvement may come at the cost of increased SLLs and the emergence of grating lobes.

In aspects, the choice of inter-element spacing may depend on the specific requirements of the application. For instance, applications requiring high directivity may benefit from larger spacings, while those prioritizing sidelobe suppression may opt for smaller spacings. In cases, the phased array antenna system may be designed with variable spacing to allow for dynamic adjustment of the emission pattern based on operational needs.

It is noted that while FIGS. 2B-2D illustrate square array configurations, the principles demonstrated may also apply to other array geometries, including the spiral configurations described elsewhere in this disclosure. The setting of antenna element 102 placement in improved spiral patterns may aim to achieve the benefits of increased directivity while mitigating the drawbacks of high SLLs and grating lobes that can occur with uniform spacing in traditional array configurations.

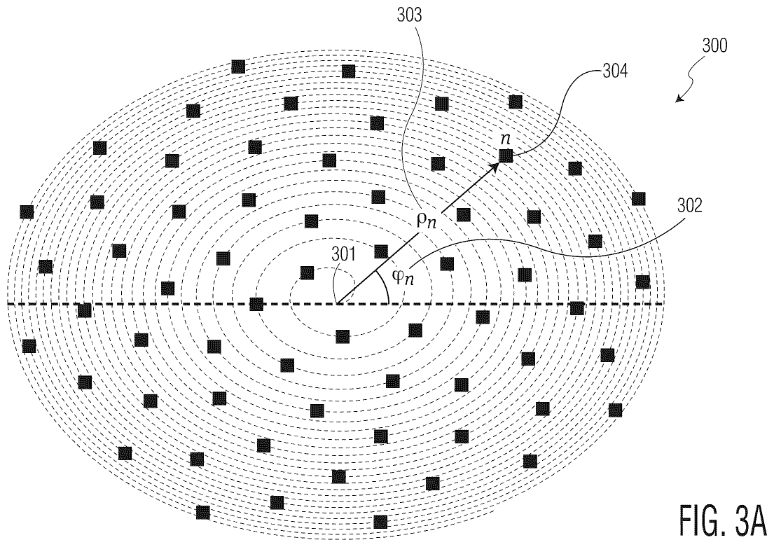

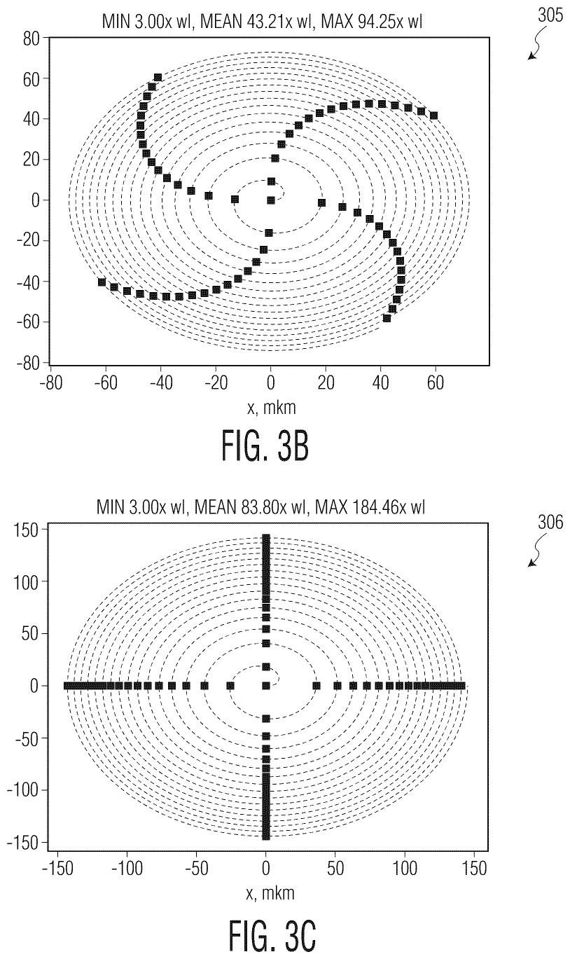

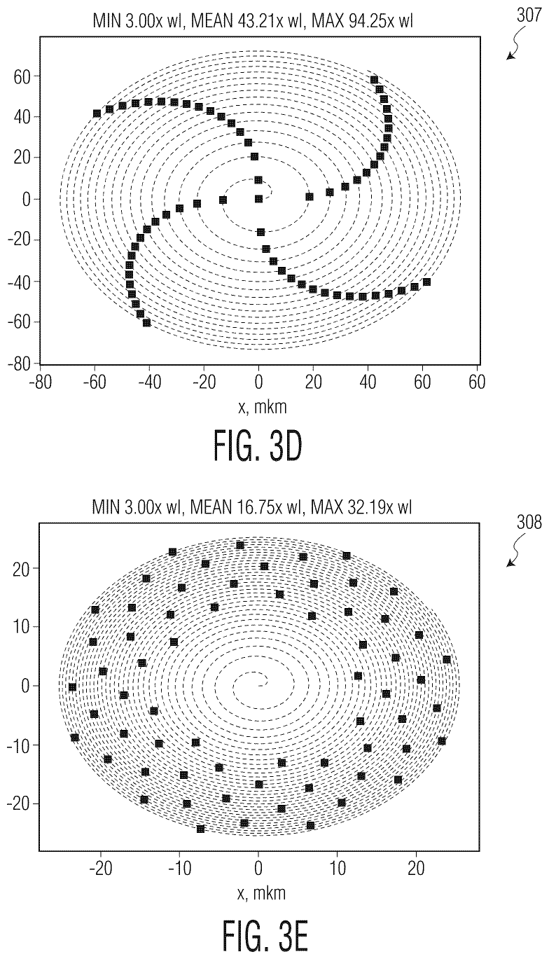

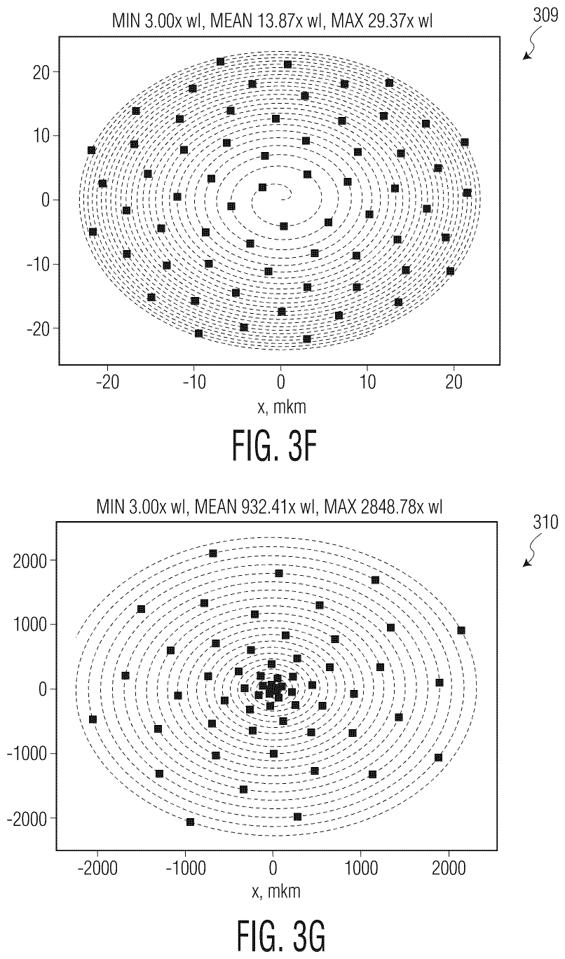

Referring now to FIG. 3A, a top view of a spiral array 300 for a phased array antenna system is illustrated. The spiral array 300 may include plurality of antenna elements (e.g. element 304) arranged in a spiral pattern emanating from a spiral center 301. In aspects, the spiral pattern may be defined based on setting of parameters defining physical placement of the antenna elements relative to one another on the improved spiral pattern and relative to the spiral center 301 to minimize sidelobes of an interference pattern produced by transmitted energy or received energy via the antenna elements.

The position of each antenna element in the spiral array 300 may be defined by two parameters: an angular position 302 φₙ and an antenna element distance from center 303 ρₙ. These parameters may determine the unique location of each antenna element within the spiral pattern. For example, an n^{th} antenna element 304 is shown to demonstrate how these parameters apply to a specific element in the array. The angular position 302 φₙ may represent the angle between a reference line and the line connecting the spiral center 301 to the nth antenna element 304. The antenna element distance from center 303 ρₙ may represent the radial distance from the spiral center 301 to the n^{th} antenna element 304.

In cases, the parameters defining the physical placement of the antenna elements may include a spiral power parameter p, an angular step parameter α, and a spiral start parameter nₛ. The spiral power parameter p may define how tightly the spiral is wound. For instance, when p=0.5, the spiral array 300 may form a Fermat spiral where the spacing between successive turns decreases gradually. When p=1, the spiral array 300 may form an Archimedean spiral with constant spacing between turns. Values of p>1 may result in the spiral expanding more rapidly, while values of 0<p<1 may cause the spiral to expand more slowly.

The angular step parameter α may define the angle between consecutive antenna elements. Larger α values may result in fewer antenna elements per spiral revolution, while smaller a values may create smoother distributions with more antenna elements per revolution. The spiral start parameter nₛ may define the starting point of the spiral. When nₛ=0, the first antenna element may be placed at the spiral center 301. Increasing nₛ may move the starting point outward along the spiral, creating a central empty area in the array.

The physical position (ρₙ, φₙ) of the n^{th} antenna element may be given by the following equations:

$${ρ}_{n} = d \cdot {( n + {n}_{s} )}^{p} \qquad ( 3 )$$

$${φ}_{n} = α ( n + {n}_{s} ) \qquad ( 4 )$$

Where n is the antenna element number (starting from 0), and dis a dimensional parameter that scales the array structure. The dimensional parameter d may be a physical scaling factor that determines the overall size of the spiral array 300. Changing d may uniformly scale the array larger or smaller without altering the relative positions of the antenna elements.

By adjusting these parameters, the spiral array 300 may be improved to minimize sidelobes in the interference pattern produced by the transmitted or received energy via the antenna elements. The spacing between elements may change gradually as the spiral expands outward from the center, creating a non-uniform distribution that may contribute to the array's performance characteristics.

In aspects, the antenna elements in the spiral array 300 may be optical emitters, acoustic emitters, radio frequency emitters, optical receivers, acoustic receivers, or radio frequency receivers. The specific type of antenna elements used may depend on the intended application of the phased array antenna system.

Referring now to FIGS. 3B-3G, various spiral antenna element patterns for a phased array antenna system are illustrated. These figures demonstrate how adjusting parameters of the spiral pattern may affect the resulting configurations and potentially impact array performance.

The spiral start parameter nₛ is a beneficial parameter for optimal spiral design. The integer part of nₛ means number of omitted elements and the fraction part means the normalized shift along spiral.

FIG. 3B depicts a spiral antenna element pattern 305 with antenna elements arranged in a curved, S-shaped configuration with 4 segments. This pattern may result from a combination of parameters where the angular step α is slightly less than 2π/4 (e.g. rational number of π with 4 in the denominator), the spiral power p is 0.5, and the spiral start nₛ is 0. The curved arms of the pattern bring regularity to the pattern, thereby increasing the sidelobe level.

FIG. 3C illustrates a spiral antenna element pattern 306 where the antenna elements are positioned in a cross-like formation. This configuration may be achieved by setting the angular step α to 2π/4, with the spiral power p at 0.5 and the spiral start nₛ at 0. The symmetrical arrangement of antenna elements along four straight lines intersecting at the center also bring regularity to the pattern, thereby increasing the sidelobe level.

FIG. 3D shows a spiral antenna element pattern 307 similar to FIG. 3B, but with the curved arms oriented in the opposite direction. This pattern may result from an angular step α slightly greater than 2π/4 (e.g. rational number of π with 4 in the denominator), while maintaining the spiral power p at 0.5 and the spiral start nₛ at 0. Such regularity in the pattern increases sidelobe level.

FIG. 3E presents a spiral antenna element pattern 308 with antenna elements distributed more uniformly across the circular area with an empty space in the center. This configuration may be achieved by setting the spiral start nₛ to a higher value, such as 20, while using an angular step α close to the golden angle (approximately 2.4 radians). The increased spiral start value creates a larger empty area at the center of the pattern, which may contribute to improved sidelobe suppression in cases.

FIG. 3F illustrates a spiral antenna element pattern 309 with a homogeneous distribution of the elements along the plane. This configuration may be achieved by using a small spiral start nₛ which causes smaller overall antenna diameter. The depicted configuration with α=2.399 (Golden Angle), nₛ=1 and p=0.5 is usually referred to as Vogel spiral. This spiral minimizes clustering and creates a visually appealing, evenly distributed pattern, being beneficial for tight packaging of elements. This, configuration, however, is not always optimal for sidelobe level control.

FIG. 3G displays a spiral antenna element pattern 310 that demonstrates exploding distance behavior. This pattern may result from using a spiral power p of 1.5. The higher spiral power value causes non-uniform spacing between antenna elements.

In aspects, the spiral antenna element patterns 305, 306, 307, 308, 309, and 310 may be improved for various performance characteristics such as sidelobe suppression, beam steering capabilities, or specific radiation pattern requirements. The ability to adjust the angular step α, spiral power p, and spiral start nₛ parameters may allow for fine-tuning of the antenna array configuration to meet diverse application needs such as sidelobe suppression.

The improved spiral antenna element patterns illustrated in FIGS. 3E and 3F may represent a range of possible configurations achievable through the optimization of spiral array parameters. Of course, other configurations are possible by tuning the parameters accordingly. By selecting and adjusting these parameters, the phased array antenna system may be tailored to meet specific performance requirements across a variety of applications, such as radar systems, wireless communications, or imaging technologies.

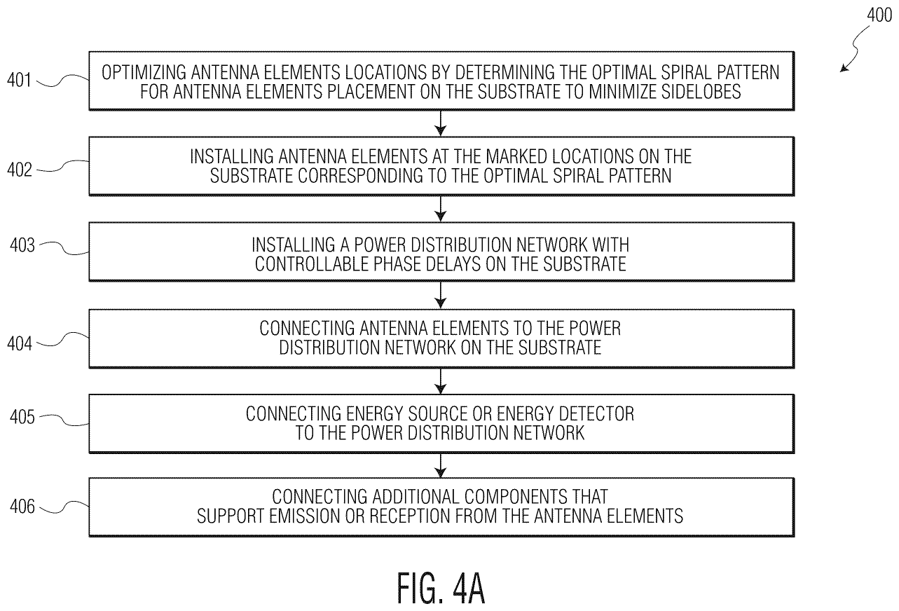

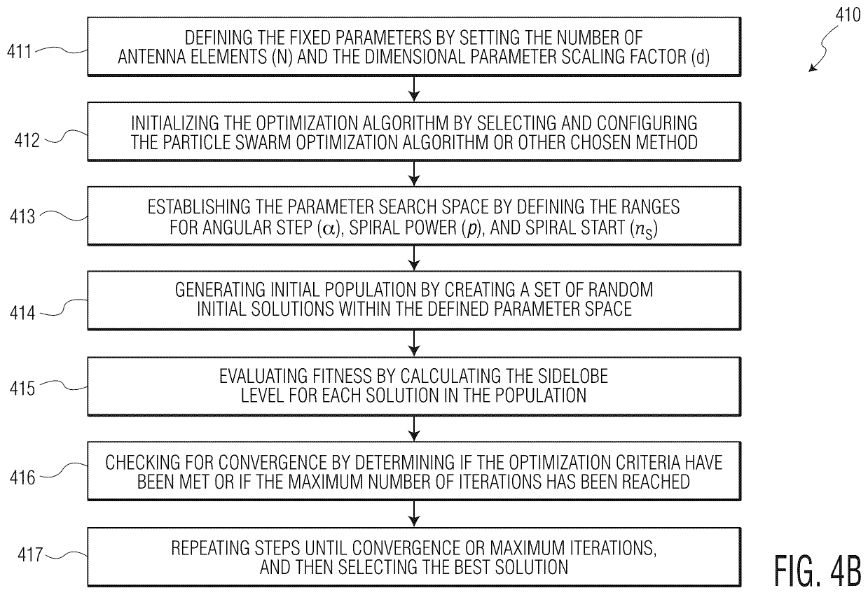

Referring to FIG. 4A, a flowchart illustrates a method 400 for fabricating a phased array antenna system. The method 400 may include several steps for setting and assembling the components of the phased array antenna system. These steps may include step 401 of setting (e.g. optimizing) antenna element locations, step 402 of installing antenna elements, step 403 of installing a power distribution network, step 404 of connecting antenna elements to the power distribution network, step 405 of connecting an energy source or energy detector, and step 406 of connecting additional components.

The method 400 may begin with a step 401 of setting (e.g. optimizing) antenna element locations. In this step, the improved spiral pattern for antenna element placement on the substrate may be determined to minimize sidelobes. An optimization process may involve using algorithms such as particle swarm optimization to determine the best values for parameters such as spiral power, angular step, and spiral start. These parameters may define how tightly the spiral is wound, the angle between consecutive antenna elements, and the starting point of the spiral, respectively.

In aspects, the optimization process for the spiral array may involve a multi-objective approach, considering not only sidelobe suppression but also factors such as main lobe width, and array compactness. The optimization algorithm may explore the parameter space defined by the spiral power p, angular step α, and spiral start nₛ to find configurations that balance these various performance metrics. For instance, a particle swarm optimization algorithm may be employed to iteratively adjust these parameters, evaluating the resulting array configurations against a composite fitness function that weighs the different objectives according to their relative importance for the specific application.

The optimization process may also take into account practical constraints such as minimum inter-element spacing and maximum array size. For example, in cases, the algorithm may incorporate penalties for configurations that violate these constraints, guiding the search towards feasible solutions. The process may involve multiple optimization runs with different initial conditions or parameter ranges to ensure a thorough exploration of the design space. In implementations, the optimization may be performed for different numbers of antenna elements, allowing designers to evaluate the trade-offs between array size and performance. For instance, an array with 64 elements may be compared to one with 128 elements to determine if the additional complexity offers significant performance improvements for a given application. Further details of optimization will be described with reference to FIG. 4B.

Following the optimization, the method 400 may proceed to a step 402 of installing antenna elements at the marked locations on the substrate. The antenna elements may be placed according to the optimized spiral pattern determined in step 401. In cases, these antenna elements may be optical emitters or receivers, while in other cases they may be radio frequency or acoustic emitters or receivers.

In aspects, the installation of antenna elements in step 402 may involve precise positioning techniques to ensure accurate placement according to the improved spiral pattern. This may include the use of automated pick-and-place machinery or high-precision lithographic processes, depending on the scale and type of antenna elements being used. The substrate may be prepared with alignment markers or fiducial points to guide the placement process, potentially improving the overall accuracy of the array configuration. In cases, the installation process may also incorporate real-time verification steps, such as optical inspection or electrical testing, to confirm proper placement and functionality of each antenna element before proceeding to subsequent fabrication stages.

The next step in the method 400 may be a step 403 of installing a power distribution network with controllable phase delays on the substrate. This network controls the phase of energy transmitted or received by each antenna element. In aspects, this network may be implemented as a spiral waveguide, while in other aspects, it may include radial out-of-plane waveguides extending from each antenna element to a power distribution network. In other words, the waveguides may be 2D routed along the antenna substrate in 2D, or they may be 3D routed at an angle (e.g. perpendicular) to the antenna substrate. While this routing approach is described in the context of optical systems, similar principles may be applied to electrical and acoustic systems. In electrical implementations, the network may use printed circuit board traces or transmission lines for 2D routing, or vertical interconnects like vias or through-silicon vias for 3D routing. In acoustic systems, the network may employ acoustic waveguides or channels that can be arranged in 2D patterns on the substrate surface or extend into the substrate in 3D configurations. These routing strategies in electrical and acoustic domains may offer similar benefits in terms of design flexibility, power distribution efficiency, and system integration as their optical counterparts.

In implementations, the power distribution network installed in step 403 may incorporate tunable phase shifters or delay lines for each antenna element. These components may allow for precise control of the phase of the signal delivered to or received from each antenna element, enabling dynamic beam steering and shaping capabilities. The network may also include power dividers or combiners to manage the distribution of energy across the array. In cases, the power distribution network may be designed with consideration for minimizing losses and maintaining consistent power levels across antenna elements, or inclusion of amplifiers which may be particularly beneficial for large arrays and provide control over amplitude distribution optimization. Waveguides may be utilized in the power distribution network to efficiently route signals between components while minimizing losses.

Following the installation of the power distribution network, the method 400 may include a step 404 of connecting antenna elements to the power distribution network on the substrate. This step may ensure that each antenna element is properly coupled to the power distribution network, allowing for precise control of the phase and amplitude of energy at each element.

In aspects, the connection process in step 404 may involve multiple techniques depending on the specific antenna element and power distribution network configurations. For instance for planar assemblies, in cases where a spiral waveguide is used, evanescent coupling may be employed to connect the antenna elements to the waveguide. This may involve carefully positioning each antenna element at a precise distance from the waveguide to achieve improved coupling efficiency. In configurations using radial waveguides, direct connections may be made between each waveguide and its corresponding antenna element. In case of 3D assembly, direct connection of the waveguides or cables is made to the antenna elements. These connections may be implemented using techniques such as wire bonding, flip-chip bonding, or through-substrate vias, depending on the fabrication process and frequency of operation. In implementations, the connections may also incorporate impedance matching networks to ensure efficient power transfer and minimize reflections between the power distribution network and the antenna elements.

In step 405 an energy source or energy detector is connected to the power distribution network. In cases, the energy source may be a light source for optical applications, while in other cases it may be a radio frequency or acoustic source. Similarly, the energy detector may be a light detector, radio frequency receiver, or acoustic sensor, depending on the specific application of the phased array antenna system.

In implementations, the connection of the energy source or energy detector to the power distribution network in step 405 may involve specialized interfaces or coupling mechanisms. For optical applications, the connection may include fiber optic couplers, grating couplers, or edge-coupled waveguides to efficiently transfer light between the source/detector and the power distribution network. In radio frequency systems, the connection may utilize coaxial connectors, waveguide transitions, or integrated baluns to match impedances and minimize signal reflections. The connection may also incorporate amplifiers, filters, or other signal conditioning components to improve the performance of the phased array antenna system. In cases, the energy source or detector may be integrated directly onto the substrate alongside the antenna elements and power distribution network, potentially reducing system complexity and improving overall efficiency.

In step 406, additional components may be connected that support emission or reception from the antenna elements. These additional components may include, but are not limited to, a SLM for optical applications, a controller for managing the system, or a microlens array for further beam shaping.

In aspects, the additional components connected in step 406 may be tailored to enhance specific functionalities of the phased array antenna system. For instance, a digital signal processor may be integrated to perform real-time beam forming calculations, allowing for adaptive beam steering in dynamic environments. In cases, temperature sensors and cooling systems may be incorporated to maintain improved operating conditions for sensitive components, potentially improving system stability and longevity. The integration of these additional components may involve careful consideration of their physical placement on the substrate to minimize signal path lengths and reduce potential interference between different system elements.

It is noted that while this method 400 describes a specific sequence of steps, variations in the order and nature of these steps may be possible depending on the specific requirements and constraints of the phased array antenna system being fabricated. For example, in cases, the power distribution network may be installed before the antenna elements, or steps may be combined or further subdivided.

Referring now to FIG. 4B, a flowchart illustrates a method 410 for setting (e.g. optimizing) parameters of a spiral antenna array. The method 410 may be used to determine the improved configuration of antenna elements in a spiral pattern to minimize sidelobes in the interference pattern produced by the phased array antenna system. The method 410 may include step 411 of defining fixed parameters, step 412 of initializing the optimization algorithm, step 413 of establishing the parameter search space, step 414 of generating an initial population, step 415 of evaluating fitness, step 416 of checking convergence, and step 417 of repeating steps until convergence or maximum iterations are reached.

The method 410 may begin with step 411, which involves defining fixed parameters for the optimization process. In aspects, these fixed parameters may include the number of antenna elements N and the dimensional parameter scaling factor d. The dimensional parameter scaling factor d may determine the overall size of the array and the spacing between antenna elements. In aspects, the real-space dimensions of the array, such as its overall size and minimum spacing between elements, may be influenced by other spiral parameters. To maintain specific physical dimensions, the optimization process may involve initially calculating the array configuration with variable parameters and a normalized dimensional parameter (e.g. d=1), then rescaling the entire array to achieve the desired physical dimensions.

In implementations, step 411 may also involve defining additional fixed parameters that may influence the optimization process. These parameters may include the operating frequency or wavelength of the phased array antenna system, which may affect the improved spacing between antenna elements. The step may also involve specifying the desired field of view or scanning range for the array, as this may impact the improved spiral configuration. In cases, system-specific constraints such as power consumption limits, heat dissipation requirements, or physical size restrictions may be defined as fixed parameters. These additional fixed parameters may help to further refine the optimization process and ensure that the resulting spiral antenna array configuration is tailored to the specific application and operational requirements of the phased array antenna system.

In step 412, the method 410 may initialize the optimization algorithm. In cases, a particle swarm optimization algorithm may be used for this purpose. The particle swarm optimization algorithm may be particularly well-suited for optimizing the spiral array parameters due to its ability to efficiently search large, multi-dimensional parameter spaces. However, other optimization algorithms may also be used in alternative implementations.

In aspects, the initialization of the optimization algorithm in step 412 may involve setting up parameters that govern the behavior of the chosen algorithm. For particle swarm optimization, this may include defining the number of particles in the swarm, setting the inertia weight, and determining the cognitive and social acceleration coefficients. The initial positions and velocities of the particles in the parameter space may be randomly generated within predefined bounds to ensure a diverse starting population. In cases, the initialization process may also incorporate problem-specific knowledge or heuristics to guide the initial distribution of particles towards potentially promising regions of the search space, potentially accelerating convergence to an improved solution.

Step 413 of the method 410 may involve establishing the parameter search space. This step may define the ranges for parameters that determine the spiral pattern, such as the angular step α, spiral power p, and spiral start nₛ. The search space may be carefully defined to ensure that potentially improved configurations are considered while avoiding unnecessary computational overhead.

The parameter search space established in step 413 may be defined based on theoretical considerations, empirical data from previous experiments, or domain-specific knowledge. The range for the angular step α may be chosen to explore various angular separations between consecutive antenna elements, potentially including values that correspond to known improved configurations such as the golden angle. The spiral power p range may be selected to investigate different rates of radial expansion, from tightly wound spirals to more loosely distributed configurations. The search space for the spiral start nₛ parameter may be defined to explore various central void sizes in the array and overall size, which may impact the overall array performance. In cases, the parameter ranges may be dynamically adjusted during the optimization process to focus on promising regions of the search space, potentially improving the efficiency of the optimization algorithm.

In step 414, an initial population of potential solutions may be generated. Each solution in this population may represent a specific combination of spiral parameters within the defined search space. This initial population may serve as the starting point for the optimization process.

In aspects, the generation of the initial population in step 414 may involve creating a diverse set of candidate solutions to explore the parameter space effectively. The method may employ various techniques to ensure a well-distributed initial population. For instance, Latin Hypercube Sampling may be used to generate a set of solutions that are evenly spread across the parameter space, potentially improving the chances of finding global optima. Additionally, the method may incorporate domain-specific knowledge to bias the initial population towards regions of the parameter space that are likely to yield good results based on prior experience or theoretical considerations. In cases, the initial population may also include known good solutions from previous optimization runs or manually designed configurations, which may help to accelerate the convergence of the optimization process. The arrays can also be rescaled to fit the required overall size or minimal inter-device distance or other real space dimensions.

Step 415 of the method 410 may involve evaluating the fitness of each solution in the population. In the context of the spiral antenna array, the fitness may be determined by calculating the SLL for each potential configuration. Lower SLLs may generally indicate better performance and thus higher fitness.

The fitness evaluation in step 415 may involve simulating the radiation pattern of each spiral antenna array configuration using computational electromagnetic techniques. These simulations may take into account factors such as mutual coupling between antenna elements, substrate effects, and feed network characteristics. The SLL may be calculated from the simulated radiation pattern, potentially considering multiple scan angles or frequency bands to assess the array's performance across its intended operating range. In cases, additional performance metrics such as main lobe width, beam steering range, or power efficiency may be incorporated into the fitness calculation, allowing for multi-objective optimization of the spiral array configuration.

The method 410 may then proceed to step 416, where convergence is checked. This step may determine whether the optimization criteria have been met or if the maximum number of iterations has been reached. The convergence criteria may be based on factors such as the improvement in sidelobe suppression between iterations or the best SLL achieved.

In aspects, the convergence check in step 416 may involve multiple criteria to ensure a robust optimization process. The method may evaluate the rate of improvement in the best solution found, comparing it to a predefined threshold. If the improvement rate falls below this threshold for a specified number of consecutive iterations, the algorithm may be considered to have converged. Additionally, the method may assess the diversity of the population, as a loss of diversity may indicate convergence to a local optimum. In cases, the convergence check may also consider the computational resources used, such as elapsed time or number of function evaluations, to balance optimization quality with practical constraints. If the convergence criteria are not met and the maximum number of iterations has not been reached, the method may proceed to generate a new population of solutions based on the current best performers, potentially incorporating mutation or crossover operations to explore new regions of the parameter space. The method may evaluate the robustness of the solution with respect to potential errors in antenna element placement due to manufacturing tolerances. This evaluation may be performed, for example, by applying random displacements to all antenna elements or the free parameters alpha, p and nₛ, or through other means, and assessing the resulting level of performance degradation. The analysis may involve simulating multiple iterations with different random perturbations to characterize the sensitivity of the array performance to positioning errors. This robustness assessment may inform design decisions regarding manufacturing precision requirements or the need for post-fabrication calibration techniques. The results may also guide the selection of array configurations that maintain acceptable performance even in the presence of minor positioning inaccuracies.

In step 417, the method 410 may repeat the previous steps until convergence is reached or the maximum number of iterations is completed. This iterative process may involve updating the parameters of each solution based on the optimization algorithm's rules, re-evaluating fitness, and checking for convergence in each iteration. Once the process is complete, the best solution may be selected based on the lowest achieved SLL.

Step 417 may involve adaptive strategies to enhance the optimization process. The method may dynamically adjust the optimization parameters, such as the inertia weight or acceleration coefficients in particle swarm optimization, based on the progress of the search. This adaptive approach may help balance exploration and exploitation of the search space, potentially improving the algorithm's ability to escape local optima and find better global solutions. Additionally, the method may incorporate parallel processing techniques to evaluate multiple solutions simultaneously, which may significantly reduce the overall computation time for large-scale optimization problems involving complex spiral antenna array configurations.

The optimization process described in method 410 may allow for fine-tuning of the spiral array configuration to achieve improved performance in terms of sidelobe suppression. By systematically exploring the parameter space and iteratively adjusting the spiral pattern, the method may identify configurations that offer superior beam forming capabilities compared to traditional uniform array designs or non-optimized spiral patterns.

In aspects, the optimization process may be extended to consider additional factors beyond sidelobe suppression, such as main lobe width, beam steering range, or system complexity. The specific optimization criteria and constraints may be adjusted based on the requirements of the particular application or use case for the phased array antenna system.

In a specific use case design for the method steps in FIG. 4B, the optimization process may be applied to develop a phased array antenna system for a satellite-based Earth observation mission. In this scenario, the antenna array may operate in the X-band frequency range (8-12 GHz) and provide high-resolution imaging capabilities.

The process may begin with step 411, where fixed parameters are defined. For this Earth observation mission, the number of antenna elements N may be set to 256 to achieve the desired spatial resolution. The dimensional parameter scaling factor d may be initially set to 0.6λ, where λ is the wavelength corresponding to the center frequency of 10 GHz. Additional fixed parameters may include the satellite's orbital altitude, the desired ground swath width, and the maximum allowable power consumption for the antenna system.

In step 412, the particle swarm optimization algorithm may be initialized with 500 particles, representing different spiral array configurations. The algorithm parameters may be tuned based on previous experience with similar optimization problems in antenna design. The inertia weight may be set to 0.7, and the cognitive and social acceleration coefficients may both be set to 1.5.

Step 413 may involve establishing the parameter search space. For this Earth observation antenna, the angular step α range may be set from 0.1 to 3.2 radians, the spiral power p range from 0 to 2.0, and the spiral start nₛ range from 0 to 256. These ranges may be chosen based on theoretical considerations and empirical data from previous X-band antenna designs.

In step 414, an initial population of 500 potential solutions may be generated using Latin Hypercube Sampling to ensure a well-distributed exploration of the parameter space. Some known good configurations from previous X-band antenna designs may also be included in this initial population to potentially accelerate convergence.

The fitness evaluation in step 415 may involve simulating the radiation pattern of each spiral array configuration using a full-wave electromagnetic solver. The fitness function may primarily consider the peak SLL but may also incorporate secondary objectives such as main lobe beamwidth and cross-polarization levels, which are beneficial for high-resolution Earth observation imaging.

In step 416, the convergence of the optimization process may be checked. For this Earth observation antenna design, the convergence criteria may include a threshold for the improvement in peak SLL between iterations. If the improvement falls below 0.1 dB for 10 consecutive iterations, the algorithm may be considered to have converged. Additionally, the diversity of the population may be assessed by calculating the standard deviation of the fitness values across particles. If this diversity measure falls below a threshold, it may indicate convergence to a local optimum. The solution robustness can be assessed by giving random displacements within the production tolerances for all antenna elements and checking the level of performance degradation. If the SLL increase is greater than an accepted margin, the solution may be redesigned.

In step 417, the optimization process may repeat steps 414-416 until convergence is reached or a maximum of iterations (e.g. 1000) is completed. During each iteration, the particle positions and velocities may be updated based on the particle swarm optimization algorithm rules. The inertia weight may be dynamically adjusted, starting at 0.9 and linearly decreasing to 0.4 over the course of the optimization. This adaptive approach may help balance exploration of the search space in early iterations with exploitation of promising regions in later iterations.

In cases, parallel processing techniques may be employed to evaluate multiple spiral array configurations simultaneously. This parallel approach may significantly reduce the overall computation time, allowing for more thorough exploration of the parameter space within the time constraints of the antenna design process.

Once the optimization process is complete, the best solution may be selected based on the lowest achieved peak SLL. This optimized spiral array configuration may then be further refined through detailed electromagnetic simulations and prototype testing to ensure it meets the requirements for the satellite-based Earth observation mission.

Referring to FIG. 5A and FIG. 5B, minimum inter-element distance graphs 501 and 502 are shown for different spiral array configurations. These graphs illustrate how various parameters affect the minimum distance between antenna elements 102 in a spiral array 300.

In FIG. 5A, the minimum inter-element distance graph 501 displays the relationship between the angular step α and the minimum distance between antenna elements 102 for a spiral array 300 with a fixed ratio of dimensional parameter to wavelength d/λ of 3. The graph 501 may include multiple curves representing different configurations, such as variations in the spiral start parameter nₛ.

FIG. 5B shows the minimum inter-element distance graph 502, which compares the performance for spiral arrays 300 with different numbers of antenna elements 102. This comparison allows for analysis of how the number of antenna elements 102 affects the minimum inter-element distance across different angular step values.

The graphs 501 and 502 may provide valuable insights into the design of spiral arrays 300. For example, they may reveal that increasing the spiral start parameter nₛ can lead to larger minimum inter-element distances, potentially reducing mutual coupling between antenna elements 102. Additionally, the graphs may show that some angular step values result in local maxima or minima of the minimum inter-element distance, which may be useful for controlling array performance.

In aspects, the change in the ratio of dimensional parameter to wavelength d/λ may scale the distance without altering the overall distribution pattern. This property may allow designers to apply the insights gained from these graphs across different frequency ranges by simply scaling the physical dimensions of the array.

The information provided by these graphs may be beneficial for designing the spiral array configuration to achieve desired performance characteristics, such as minimizing sidelobes or maximizing beam steering capabilities. By carefully selecting the angular step, spiral start parameter, and number of antenna elements, designers may create spiral arrays that balance various performance trade-offs and meet specific application requirements.

In aspects, the model parameters may be split into two groups. The first group may include the practically-defined (fixed) parameters: dimensional parameter d and number of elements N. These parameters may be naturally limited by the technology—the dimensional parameter may not be less than the size of individual emitter (plus some space for cross-talk isolation and some pump routing) and the number of elements may be limited by the available area and phase control capabilities. For these parameters, general trends may be suggested and the SLL may be assumed to be more-or less monotonous with them. The second group may include free parameters: angular step α, spiral power p and spiral start number nₛ. For each particular fixed parameter state, an improved combination of free parameters may exist.

The influence of the scaling parameter may be discussed in the theoretical part. This parameter may scale the directionality diagram in the direction of elevation angle. Thus, sidelobes may shift to the center from infinity, decreasing their width simultaneously. It may be noted that sin(θ) scales, and therefore the deformation may not be linear for large angles. The directionality diagram discretization may also be adapted for the scaling parameter. In aspects, a 1500×1000 mesh (θ, φ) may be used for the hemisphere, which may be sufficient for modelling up to d/λ≈7 for N=64 with 5% accuracy. It may also be noted that d/λ=0.5 may be an upper bound of dimension parameter before which sidebands tend to decrease with the distance from the central lobe. In this region a first sidelobe near the main lobe may be the largest. In other words, θ_{c}=aresin(0.5λ/d) may be a good approximation of the beginning of the region with the high sidebands. This may work better for homogeneous (Vogel-like) emitter distribution, and the more structured the array, the closer this line may be to the main lobe.

Specifically, in FIGS. 5C-5D, scaling diagrams of a Fermat spiral antenna are shown. FIG. 5C illustrates a scaling of a Fermat spiral antenna diagram 503 with a main lobe width at 1.08 degrees and a sideband of −8.31 dB. FIG. 5D displays a scaling of a Fermat spiral antenna diagram 504 with a main lobe width at 0.54 degrees and a sideband of −8.32 dB.

In aspects, the scaling diagrams 503 and 504 may illustrate the effect of changing the dimensional parameter d/λ on the antenna's emission pattern. The dimensional parameter d/λ may represent the ratio of the characteristic distance between antenna elements to the wavelength of the emitted or received energy. As this ratio increases, the main lobe of the antenna pattern may become narrower and shift towards smaller angles.

The scaling diagrams 503 and 504 may demonstrate how the dimensional parameter d/λ affects the overall emission pattern of the Fermat spiral antenna. In cases, increasing the d/a ratio may result in a more focused main lobe, potentially improving the directivity of the antenna. However, this increase may also lead to the appearance of grating lobes or aliases at larger angles, which may be undesirable in some applications.

The dotted lines 503(A) and 504(A) shown in both diagrams 503 and 504 may represent the function aresin(0.5λ/d). This line may serve as an approximation for the boundary between the main lobe region and the region where high sidelobes or grating lobes may appear.

Similarly, dots 503(B) and 504(B) visible in the diagrams 503 and 504 indicate the positions of the first maximal sidelobes. The location and intensity of these sidelobes may be beneficial factors in assessing the performance of the antenna array. In cases, the optimization of the spiral pattern parameters may aim to minimize these sidelobes while maintaining a narrow and well-defined main lobe.

The comparison between diagrams 503 and 504 may illustrate how changing the d/λ ratio from 1.5 to 3 affects the antenna pattern. This change may result in a narrower main lobe and a shift in the positions of the sidelobes. In aspects, this scaling property may allow for the design of antennas with similar performance characteristics across different frequency ranges by adjusting the physical dimensions of the array while maintaining the same spiral pattern.

In aspects, the diagram of the SLL dependence on the dimension parameter may be constructed to demonstrate that the d/λ does not change the lobe levels, but may bring about higher lobe levels. It may be observed that at d/λ<0.5 the SLL is the same as the first sideband and then it may increase stepwise with the scaling. It may also be seen that for higher number of emitters the first sideband level may saturate and moreover, after some threshold the range where no new sidelobes are greater may increase considerably. Such behavior may have been reported in previous studies.

The change of the emitter number may bring more complex consequences, including both scaling and reduction of the sidelobes. It may be observed that first sidebands area θ<θ_{c} is shrinking towards θ=0. There may also be some attraction points beyond θ_{c} to which the diagram shrinks locally. The overall sidelobe reduction with N in this area may be greater than in the remaining space, so eventually, the first sideband may become the highest of the sidebands. Due to this it may be seen that the SLL dependence on N tends to the limiting case of d/λ=0.5. It may be found that this behavior is similar for different angular steps a, however the limiting case may change with the spiral starting point nₛ. The smoothness of the first sideband may be somewhat distorted for low number of emitters N<14 as a regular first sideband may not be fully formed.

FIGS. 5E-5F, the Vogel spiral array SLL graphs 505, 506 illustrate the performance characteristics of Vogel spiral antenna arrays with respect to SLLs. In aspects, the Vogel spiral array SLL graph 505 may display the relationship between the SLL in decibels and the ratio of inter-element distance to wavelength d/λ for various numbers of antenna elements N. The graph 505 may show how the SLL changes as the dimensional parameter d/λ increases for different array sizes.

In cases, as the dimensional parameter d/λ increases, the SLL may initially remain constant before experiencing step-wise increases. This behavior may be attributed to the emergence of higher-order sidelobes as the inter-element spacing grows relative to the wavelength. The graph 505 may also indicate that arrays with a larger number of antenna elements tend to maintain lower SLLs over a wider range of dimensional parameters.

The Vogel spiral array SLL graph 506 may illustrate the SLL performance as a function of the number of array elements N for different d/λ ratios. This graph 506 may provide insights into how increasing the number of antenna elements affects the sidelobe suppression capabilities of Vogel spiral arrays. In aspects, the graph 506 may show that for a given d/λ ratio, increasing the number of antenna elements generally leads to improved sidelobe suppression, with the effect being more pronounced for smaller d/λ values. In aspects, the graph 506 exhibits a saturation effect for square and Vogel spiral arrays. After approximately 100 and 128 elements, the decrease in sidelobe level (SLL) may plateau around −13.3 dB and −17.5 dB respectively. The parameter setting approach presented in this disclosure overcomes this non-scalability issue, potentially allowing for further reductions in SLL beyond the saturation point observed in conventional designs.

The graph 506 may also include a comparison to a square array configuration, represented by a separate curve. This comparison may allow for a direct assessment of the performance benefits offered by the Vogel spiral arrangement over traditional square arrays. In cases, the Vogel spiral configuration may demonstrate superior sidelobe suppression capabilities, particularly as the number of antenna elements increases.

The information presented in these graphs 505, 506 may be valuable for antenna array designers in optimizing the trade-offs between array size, inter-element spacing, and sidelobe suppression performance. By analyzing these relationships, designers may be able to select the most appropriate configuration for specific application requirements, balancing factors such as array compactness, beam steering capabilities, and sidelobe minimization.

Referring now to FIGS. 5G-5H, graphs related to Fermat spiral antenna array optimization are shown. FIG. 5G depicts an alpha scan graph 507 for Fermat spiral, displaying the SLL in dB as a function of the angular step α. The graph 507 may illustrate how varying the angular step parameter affects the SLLs in a Fermat spiral antenna array configuration.

The alpha scan 507 may reveal that the SLL varies non-monotonically with the angular step. In cases, angular step values may result in lower SLLs, potentially indicating improved configurations for the spiral antenna array. The presence of peaks and troughs in the graph 507 may suggest that careful selection of the angular step parameter may be beneficial for minimizing sidelobes in the antenna's radiation pattern. It is noted that peaks in angular step dependence FIG. 5G correspond to a values equal to rational numbers of π and to dips in FIGS. 5A and 5B.

FIG. 5H presents a starting point scan 508 for Fermat spirals, showing the SLL in dB as a function of the spiral start parameter nₛ for two different angular step α values. This graph 508 may demonstrate how these parameters affect the SLLs in Vogel-like spiral configurations. The use of two different alpha values in the graph 508 may allow for comparison of the spiral start parameter's effect under different angular step conditions.

The starting point scan 508 for Fermat spirals may indicate that the SLL varies with the parameters in a complex manner. In aspects, the graph 508 may reveal multiple local minima, suggesting that improved sidelobe suppression may be achieved at specific combinations of spiral start and angular step parameters. The presence of these minima may highlight the importance of considering both parameters in the process for designing the spiral antenna arrays. Considering all three parameters as disclosed herein provides a more significant improvement in the design process.

In cases, the graphs 507 and 508 may be used in conjunction to inform the optimization process for spiral antenna arrays. By analyzing the relationships between angular step, spiral start parameter, and SLLs, antenna designers may be able to identify configurations that minimize unwanted sidelobes while maintaining desired main beam characteristics.

The optimization process illustrated by these graphs may be applicable to various types of spiral antenna arrays, including but not limited to optical, radio frequency, and acoustic phased arrays. In aspects, the insights gained from these graphs may be used to guide parameter selection in particle swarm optimization algorithms or other optimization methods for determining improved spiral antenna array configurations.

Referring to FIGS. 51-5J, a heat map 509 of SLL and a corresponding spiral array pattern 510 for a phased array antenna system are shown. The heat map 509 of SLL may display the SLL as a function of parameters, α and nₛ. In aspects, a may represent the angular step between consecutive antenna elements, while nₛ may represent the spiral start parameter. The heat map 509 may use a shading scale ranging from darker shading which may indicate the lowest SLL values, and lighter shading which may indicate the highest SLL values.

In cases, the minimum SLL value and its corresponding position may be indicated at the top of the heat map 509. This information may be useful for identifying the improved combination of a and nₛ parameters that result in the lowest SLLs for the phased array antenna system. The spiral array pattern 510 may illustrate the spatial distribution of antenna elements in a spiral configuration based on the optimized parameters identified from the heat map 509. In this map, a global minimum over nₛ lies below nₛ=60.

The spiral array pattern 510 corresponding to the improved parameters may demonstrate how these parameters influence the physical layout of the antenna elements. In cases, the optimized spiral pattern may exhibit a non-uniform distribution of antenna elements, with varying distances between adjacent elements and a specific starting point determined by the nₛ parameter.

It may be observed that the optimization process, as visualized by the heat map 509 and resulting spiral array pattern 510, may lead to a configuration that balances the spacing and arrangement of antenna elements to minimize SLLs. This optimized configuration may contribute to improved beam forming capabilities and reduced interference in the phased array antenna system.

In aspects, the relationship between the heat map 509 and the spiral array pattern 510 may provide valuable insights into the trade-offs involved in optimizing the phased array antenna system. For instance, some parameter combinations that yield low SLLs may result in spiral patterns with specific characteristics, such as a more tightly wound spiral or a larger central void area.

Referring to FIG. 5K, a comparison of optimized spiral SLL 511 for different antenna array configurations is shown. The graph displays the SLL in dB on the y-axis versus the number of antenna elements (e.g. emitters) on the x-axis, which uses a logarithmic scale. The comparison is performed between the spiral pattern optimized by algorithm 410 for minimal inter-device distances 0.5 and 7 wavelengths (Optimal 0.5λ, Optimal 7.0λ), standard Vogel spiral (Vogel 0.5λ, Vogel 7λ), and standard square spiral (Square 0.5λ, and Square 7.0λ) with corresponding distances.

In aspects, the improved configurations may show a consistent decrease in SLL as the number of antenna elements increases. This trend suggests that the optimized spiral configurations may provide improved sidelobe suppression as the array size grows. In contrast, the Vogel and Square configurations may tend to plateau or show less improvement with increasing antenna elements.

The graph may illustrate the performance differences between arrays with different element spacings. For instance, configurations with 0.5λ spacing may exhibit different SLL characteristics compared to those with 7.0λ spacing. This comparison may highlight the impact of element spacing on sidelobe suppression across various array types.

The comparison may provide insights into the scalability of different array configurations. For example, the graph may suggest that optimized spiral arrays may be particularly well-suited for applications requiring large numbers of antenna elements while maintaining low SLLs.

It is noted that the specific performance characteristics shown in the comparison may vary depending on the optimization parameters used for the spiral configurations and the specific implementation details of each array type. The graph may serve as a general illustration of potential performance trends.

Referring to FIG. 5L, FIG. 5M, and FIG. 5N, graphs 512, 513, and 514 illustrate the optimization trends for angular step, spiral power, and spiral start parameters, respectively, as the number of antenna elements increases. These graphs show how the improved values (e.g. solid lines in FIG. 5K) for these parameters may vary depending on the number of antenna elements and the spacing between elements.

As previously mentioned, the optimization process may consider the interplay between the dimensional parameter, spiral power, and emitter step to determine the improved antenna element spacing. This interplay may be complex, as changing one parameter may affect the improved values for the others. For example, increasing the spiral power may allow for a larger angular step while maintaining a similar overall array size. Conversely, a smaller angular step may require a lower spiral power to prevent overcrowding of antenna elements near the center of the array.

In cases, the optimization trends may differ significantly between the 0.5 and 7.0 wavelength spaced arrays. This difference may highlight the importance of considering the wavelength of operation when designing the spiral array. Arrays designed for shorter wavelengths may require different improved parameter values compared to those designed for longer wavelengths, even when the number of antenna elements is the same as the sidelobe level increases with a decrease in wavelength.

The improved spiral configuration may be implemented in an optical transceiver, which is described in reference to FIGS. 6A-6E and 7. In aspects, the optical transceiver may incorporate the spiral arrangement of antenna elements to achieve improved beam forming and reduced SLLs. The figures illustrate various configurations of the phased array antenna system, including spiral waveguide and radial waveguide and out-of-plane designs, as well as the integration of a SLM for dynamic beam steering/forming. The method of operating the phased array antenna system with an SLM, as shown in FIG. 7, may demonstrate how the improved spiral configuration can be utilized in conjunction with phase modulation techniques to achieve desired beam configurations and adapt to changing operational requirements in optical communication applications.

Referring to FIGS. 6A-6B, two configurations of a phased array antenna system for optical applications are illustrated, although it is noted that other configurations are possible. In aspects, the phased array antenna system may include a plurality of antenna elements arranged in a spiral pattern on a substrate. The antenna elements may be coupled to an energy source configured to transmit energy from the antenna elements or coupled to an energy detector configured to receive energy via the antenna elements. In cases, the antenna elements may be optical emitters or optical receivers. However, in other implementations, the antenna elements may be acoustic emitters, radio frequency emitters, acoustic receivers, or radio frequency receivers.

More specifically, FIG. 6A shows a configuration with a spiral waveguide 601. The system may include a light source/detector 606 connected to the spiral waveguide 601. The spiral waveguide 601 may be arranged in a spiral pattern and may have multiple optical antenna elements 602 positioned along its length. In aspects, the optical antenna elements 602 may be evanescently coupled to the spiral waveguide 601, allowing for light transmission or reception. This configuration may provide a simpler layout with one continuous waveguide, which may be potentially easier to fabricate and maintain consistent coupling along the spiral.

In implementations, the evanescently coupled configuration may offer advantages in terms of power distribution and fabrication simplicity. The spiral waveguide 601 may be designed with a core material that has a higher refractive index than the surrounding cladding, creating an evanescent field that extends beyond the physical boundaries of the waveguide. This evanescent field may interact with the optical antenna elements 602 positioned in close proximity to the waveguide, allowing for efficient power transfer without direct physical contact. The strength of the evanescent coupling may be controlled by adjusting the distance between the waveguide and the antenna elements, as well as the refractive index contrast. In cases, the coupling efficiency may be improved for each antenna element individually by fine-tuning its position relative to the spiral waveguide 601, potentially allowing for uniform power distribution across the array despite the varying path lengths along the spiral.

FIG. 6B depicts an alternative configuration (for the same antenna placement as in FIG. 6B) using radial waveguides 604. In this arrangement, a light source/detector 606 may be connected to multiple radial waveguides 604 via power distribution network 630 which may include optical waveguides or fibers to efficiently route power from the light source/detector 606 to each of the radial waveguides 604, potentially allowing for precise control over the energy delivered to individual antenna elements. The power distribution network 630 may incorporate tunable components additional phase shifters or variable attenuators or amplifiers, which may enable dynamic adjustment of power levels across different sections of the array to improve performance or compensate for variations in antenna element efficiency. These radial waveguides 604 may extend outward in a circular pattern from the center. At the end of each radial waveguide 604 may be an optical antenna element 605. The optical antenna elements 605 may be arranged in a spiral pattern around the center of the system. This configuration may allow for direct power delivery to each antenna element and potentially more control over individual antenna element power levels.

In aspects, the radial waveguide configuration may offer additional advantages in terms of power control and phase management. The individual radial waveguides 604 may be designed with varying lengths or optical properties to introduce predetermined phase delays or power adjustments for each optical antenna element 605. This may allow for static phase and amplitude control in addition to the dynamic control provided by the SLM. The radial waveguides 604 may also incorporate on-chip optical amplifiers or attenuators to compensate for power losses along the waveguide paths or to deliberately adjust the power distribution across the array. The radial waveguides 604 may be fabricated using different materials or dimensions to improve performance for specific wavelengths or to achieve desired dispersion characteristics, potentially enabling broadband or multi-wavelength operation of the phased array antenna system.

In aspects, the light source and detector components may be implemented using advanced photonic technologies to enhance the performance and versatility of the phased array antenna system. The light source may include a tunable laser or an array of vertical-cavity surface-emitting lasers (VCSELs) capable of generating coherent light at multiple wavelengths. This multi-wavelength capability may allow for simultaneous operation across different frequency bands or enable wavelength division multiplexing for increased data capacity. The detector may incorporate sensors designed for conversion between radiation (e.g., light) and electrical signals. The detector may include integrated transimpedance amplifiers (TIAs) to improve signal-to-noise ratio and dynamic range. The light source and detector may be monolithically integrated on the same substrate as the antenna elements, potentially reducing system complexity and improving overall efficiency.

The spiral waveguide 601 or the radial waveguides 604 may extend from the antenna elements to the power distribution network or directly to the energy source or the energy detector. The spiral waveguide 601 may be evanescently coupled to the antenna elements 602, while the radial waveguides 604 may directly connect to each of the antenna elements 605. Both configurations may allow for the distribution of light from the light source to the optical antenna elements or the collection of light by the optical antenna elements for detection.

The spiral arrangement of the optical antenna elements in both configurations may be designed to improve the antenna array's performance, potentially reducing sidelobes in the emission or reception pattern. In cases, the specific arrangement of the antenna elements and the choice between spiral or radial waveguide configurations may depend on factors such as the desired beam steering capabilities, power efficiency, and fabrication constraints.

Referring now to FIG. 6C, a 3D perspective view is shown of a phased array antenna system with antenna elements 608 arranged on a substrate 607. In this configuration, the antenna elements 608 may be positioned in an improved spiral pattern on the top surface of the substrate 607, potentially allowing for improved beam forming and reduced sidelobe levels. Below the substrate 607, a light source/detector 606 may be coupled to the antenna elements 608 through a power distribution network 630. This network may include optical components designed to efficiently route light between the light source/detector 606 and the individual antenna elements 608. The power distribution network 630 may incorporate various optical devices such as splitters, combiners, or wavelength multiplexers to manage the distribution of optical power across the array. Connecting the power distribution network 630 to the antenna elements 608 may be a series of optical fibers or waveguides 609. These fibers may offer 3D routing by extending out of antenna plane such as vertically (e.g. perpendicular or some other non-zero angle) through the substrate 607 connecting to each antenna element 608 (only four connections shown for simplicity). The use of optical fibers 609 may allow for flexible routing of light signals and may help minimize losses or crosstalk between channels. Of course, waveguides or the like can be substituted for the optical fibers in certain configurations.

In aspects, 3D routing techniques such as those described above, may enhance flexibility and performance. This approach may allow for more efficient connections between the power distribution network and the antenna elements, potentially reducing system dimensions and improving overall functionality. The antenna elements themselves may be replaced by the tips of optical fibers, which may serve as emitters. These fiber tips may be positioned in the improved spiral pattern using various methods, such as a rigid non-transparent substrate with holes, clamps, or 3D-printed sockets.

The use of 3D routing may offer additional advantages in terms of system design and fabrication. The 3D routing may be achieved through laser modification of specific transparent materials, where focusing a laser beam inside the bulk material may permanently change the refractive index in localized spots. This technique, known as 3D femtosecond laser writing, may allow for the creation of complex optical pathways within the substrate. In implementations using flexible optical fibers, the area between the substrate and the power distribution network may be filled with a solidifying compound, such as epoxy, to mechanically fix the components and potentially reduce phase noise. Additionally, the chip containing these optical paths may be thermally stabilized to further minimize phase noise and enhance overall system performance.

In aspects, the phased array antenna system may also be combined with other devices such as an SLM to provide desired phase shifts for enhanced beam steering and forming capabilities. The SLM may be positioned above the antenna elements and may include an array of individually controllable pixels that can modulate the phase of light passing through them. An example of this configuration is now described.

Referring now to FIG. 6D, a block diagram of a phase array antenna system 610 including SLM 612 including top cladding layer 612(A), top ground electrode 612(B), pixel electrodes (pixels) 612(C), liquid crystals between electrodes 612(B) and 612(C) and bottom cladding layer 612(D), a photonic integrated circuit (PIC) 614 including cladding layer 614(A) and substrate 614(B), antenna elements 615 a controller 616, and a light source/detector 617 and a power distribution network 630.

The top cladding layer 612(A) may provide protection and optical isolation for the underlying components. The top ground electrode 612(B) may provide grounding for electrical control of the SLM pixels 612(C) which modulate the phase of light passing through the SLM. The bottom cladding layer 612(D) may provide optical contact between the SLM and PIC. The SLM pixels 612(C) may be arranged in a pattern (e.g. grid pattern) on bottom cladding layer 612(D).

The PIC 614 may include antenna elements 615 positioned in an improved spiral pattern within cladding layer 614(A) below the SLM pixels 612(C). Cladding layer 614(A) may host and protect waveguides and antenna elements. The substrate 614(B) may provide mechanical support. The layered structure of both the SLM and PIC may enable precise control over the optical and electrical properties needed for beam steering and shaping in the phased array antenna system. The antenna elements 615 may be coupled to the light source/detector 617 via power distribution network 630, which may either provide light for transmission or detect received light, depending on the system's operation mode.

It is noted that the SLM structure shown in FIG. 6D is an example, and that other SLM structures may be possible. The SLM may utilize different technologies, such as MEMS-based devices, electro-optic modulators, or acousto-optic modulators. The SLM may also have varying pixel sizes, arrangements, or resolutions to accommodate different antenna element configurations or beam steering requirements. Additionally, the SLM may be designed with multiple layers or integrated with other optical components to enhance its functionality or performance in specific applications.

In aspects, a beneficial feature of the phased array antenna system with SLM may be the ability to dynamically change the phase of light at each antenna element position. This capability may allow for precise control over the beam formation and steering. The SLM may provide a smooth, non-breaking coverage of the plane by its pixels, which may enable continuous and fine-grained phase modulation across the entire array. This smooth coverage may be beneficial for easier alignment of the PIC and SLM and potentially reducing unwanted artifacts in the beam pattern.

The controller 616 (e.g. processor, etc.) may be connected to both the SLM electrode 612(B), SLM pixels 612(C) and the light source/detector 617. The controller 616 may manage the operation of the SLM electrode 612(B) and SLM pixels 612(C) and coordinate with the light source/detector 617 to control the phased array antenna system. In cases, the controller 616 may be configured to control the SLM to adjust phase shifts of light emitted from the optical antenna elements 615.

In transmission operation, light from the light source 617 may pass through the antenna elements 615 on the PIC 614. The light may then travel through the SLM pixels 612(C), which may modulate the phase of the light based on signals from the controller 616. This may allow for beam steering and shaping of the transmitted light.

In reception operation, received light may pass through SLM layers 612(A) and 612(B), then through SLM pixels 612(C), which may modulate the phase of the light based on signals from the controller 616. The modulated light may be received by the antenna elements 615 on the PIC 614. This may allow for beam steering and shaping of the received light.

The arrangement of the antenna elements 615 in an improved spiral pattern in the PIC 614, combined with the phase modulation provided by the SLM pixels 612(C), may enable the system to achieve improved beam forming and reduced SLLs compared to traditional phased array designs. The SLM may be positioned to receive and modulate light emitted from or received by the optical antenna elements 615, thereby performing beam steering in both transmission and reception modes.

In aspects, the SLM may enable advanced beam forming and beam shaping capabilities in the phased array antenna system. By independently controlling the phase of light at each antenna element, the SLM may allow for precise manipulation of the overall beam pattern. This may include steering the main lobe in desired directions, adjusting the beam width, creating multiple simultaneous beams, or generating complex beam shapes for specific applications. The SLM may also facilitate adaptive beam forming, where the beam pattern can be dynamically adjusted in real-time to improve signal quality, mitigate interference, or track moving targets. In cases, the combination of the improved spiral antenna array configuration and the flexibility provided by the SLM may result in superior beam forming performance compared to traditional phased array systems, potentially offering improved spatial resolution, increased signal-to-noise ratio, and enhanced overall system efficiency.

Referring to FIG. 6E, a top view of a SLM 620 on top of the PIC with antenna elements 622-623 for use in a phased array antenna system is illustrated. The SLM 620 may include a grid-like structure of SLM pixels 621 arranged in a rectangular array. In aspects, the SLM pixels 621 may be represented by grid lines forming small squares across the surface of the SLM 620.

The SLM 620 may be configured to work in conjunction with multiple antenna elements arranged in a non-uniform pattern across its surface. In cases, these antenna elements may be positioned in a spiral pattern designed to minimize sidelobes in the interference pattern produced by the phased array antenna system. The antenna elements may be represented by squares overlaid on the grid of SLM pixels 621.

In aspects, each antenna element may be covered by at least one SLM pixel 621. This configuration may allow for precise phase control of the light emitted from or received by each antenna element. For example, antenna element 622 may be positioned within the footprints of multiple SLM pixels 621, while antenna element 623 may be positioned within the footprint of a single SLM pixel 621.

The controller of the phased array antenna system may be configured to map each of the antenna elements to corresponding pixel(s) of the SLM 620. This mapping may enable the system to individually control the phase of light associated with each antenna element by adjusting the corresponding SLM pixels 621.

In cases, the SLM 620 may enable dynamic beam steering and shaping by adjusting the phase of light at each antenna element position through control of the corresponding SLM pixels 621. The controller may be programmed to calculate and apply specific phase shifts to each SLM pixel 621 based on the desired beam configuration and the position of the associated antenna element in the spiral pattern.

The arrangement of SLM pixels 621 in relation to the spiral-patterned antenna elements may provide flexibility in phase control. For instance, antenna elements near the center of the spiral pattern may be smaller and more densely packed, potentially requiring fewer SLM pixels 621 for control. Conversely, antenna elements near the outer edges of the spiral may be larger and more widely spaced, potentially utilizing more SLM pixels 621 for finer phase control.

In aspects, the SLM 620 may include a transmissive liquid crystal on silicon device. The use of such a device may allow for high-resolution phase control while maintaining a compact form factor suitable for integration with the phased array antenna system.

Referring now to FIG. 7, a flowchart illustrates a method 700 for operating a phased array antenna system with SLM. The method 700 in FIG. 7 includes step 701 (activating the spiral optical antenna element array and SLM), step 702 (determining the desired beam configuration), step 703 (calculating specific phase shifts for each antenna element), step 704 (applying calculated phase shifts by configuring SLM pixels), step 705 (modulating the light phase), step 706 (monitoring beam quality), and step 707 (repeating the process for dynamic beam configuration).

The method 700 may begin with step 701, which may involve activating the spiral optical antenna element array and SLM. This step may include powering on the PIC containing the improved spiral array of antenna elements 615 and SLM pixels 612(C).

In step 702, the desired beam configuration may be determined. This step may involve calculating the desired phase shifts for each antenna element 615 to configure the beam as desired. The controller 616 may be configured to determine these phase shifts based on the desired beam direction.

In step 702, the determination of the desired beam configuration may involve considering multiple factors that influence the overall performance of the phased array antenna system. The controller 616 may take into account parameters such as the target direction, desired beam width, sidelobe suppression requirements, and any specific beam shaping needs for the intended application. In cases, the controller 616 may utilize pre-defined beam patterns stored in a lookup table, or it may dynamically calculate the improved beam configuration based on real-time inputs from sensors or user commands. The process may also involve evaluating trade-offs between different performance metrics, such as balancing maximum directivity with wider angular coverage, to achieve the most suitable beam configuration for the current operational scenario.

Step 703 may involve calculating specific phase shifts for each antenna element 615. These calculations may be based on the antenna element's position in the spiral array and the desired beam configuration. The controller 616 may perform these calculations to ensure precise beam steering.

In step 703, the controller 616 may utilize advanced algorithms to calculate the specific phase shifts for each antenna element 615. These algorithms may take into account the unique spiral arrangement of the antenna elements, considering factors such as the radial distance and angular position of each element relative to the array center. The phase shift calculations may also incorporate compensation for any inherent phase differences due to varying path lengths in the spiral configuration, potentially ensuring coherent beam formation in the desired direction.

The phase shift calculations in step 703 may involve iterative optimization techniques to fine-tune the phase values for each antenna element 615. The controller 616 may employ methods such as gradient descent or genetic algorithms to minimize a cost function that considers both the main lobe direction and SLLs. This approach may allow the system to achieve improved beam forming performance while adapting to the specific characteristics of the spiral array configuration.

In step 704, the calculated phase shifts may be applied by configuring the SLM pixels 612(C). The controller 616 may send signals to the SLM electrode 612(B) and SLM pixels 612(C) to adjust the phase of light passing through the device. This step may enable the system to impart the desired phase shifts to the light emitted from or received by the antenna elements 615.

In step 704, the controller 616 may utilize a mapping algorithm to associate each antenna element 615 with its corresponding SLM pixels 612(C). This mapping may take into account the spatial relationship between the spiral-arranged antenna elements and the grid-like structure of the SLM. In cases, the controller 616 may apply interpolation techniques to achieve sub-pixel phase control, potentially allowing for finer granularity in beam steering and shaping. The configuration process may also involve calibration routines to compensate for any manufacturing variations or non-uniformities in the SLM pixels 612(C), which may help ensure accurate and consistent phase control across the array.

Step 705 may involve modulating the light phase. The SLM pixels 612(C) may adjust the phase of the light according to the applied configuration. This modulation may allow for precise control over the beam's direction and shape.

In step 705, the SLM pixels 612(C) may modulate the phase of the light passing through them based on the configuration applied in the previous step. This modulation may occur on a pixel-by-pixel basis, with each SLM pixel 612(C) adjusting the phase of the light independently. The phase modulation may be achieved through various mechanisms, such as changing the refractive index or optical path length within each pixel. In cases, the SLM may utilize liquid crystal technology, where the orientation of liquid crystal molecules in each pixel can be electrically controlled to alter the phase of the transmitted light.

The phase modulation process may be highly precise, potentially allowing for phase adjustments on the order of fractions of a wavelength. This level of control may enable the phased array antenna system to achieve fine-grained beam steering and shaping capabilities. The SLM may be capable of applying continuous phase shifts rather than discrete steps, which may further enhance the system's ability to generate complex beam patterns and minimize unwanted sidelobes.

In step 706, the system may monitor beam quality. This step may involve assessing the formed beam for sidelobe suppression and main lobe configuration. The controller 616 may be configured to analyze the beam quality and make adjustments as needed. Additionally, the controller 616 may fine-tune the SLM configuration to compensate for any atmospheric or environmental effects that may impact beam quality.

In aspects, the monitoring of beam quality in step 706 may involve real-time analysis of the beam pattern using various sensing techniques. The system may employ feedback mechanisms, such as integrated power detectors or external monitoring devices, to measure the actual beam characteristics and compare them to the desired configuration. This continuous monitoring may allow the controller 616 to detect and respond to any deviations from the intended beam pattern, potentially caused by factors such as atmospheric turbulence, temperature fluctuations, or mechanical vibrations. The controller 616 may use this feedback to implement adaptive algorithms that dynamically adjust the SLM configuration, potentially maintaining improved beam quality under changing environmental conditions.

Finally, step 707 may involve repeating the process for dynamic beam configuration. The controller 616 may be configured to continuously update the SLM configuration to change the beam configuration as needed for various applications. This dynamic updating may allow for real-time scanning or tracking capabilities.

In aspects, the dynamic beam configuration process in step 707 may involve adaptive algorithms that continuously improved the beam pattern based on real-time feedback and changing operational requirements. The controller 616 may implement machine learning techniques, such as reinforcement learning, to improve the system's beam forming performance over time. This approach may allow the phased array antenna system to adapt to complex and dynamic environments, potentially enhancing its effectiveness in applications such as satellite communications, radar systems, or wireless networks. The controller 616 may also incorporate predictive algorithms to anticipate changes in the target's position or environmental conditions, enabling proactive adjustments to the beam configuration for improved tracking and signal quality.

In aspects, the controller 616 may employ adaptive algorithms to improve beam quality over time. These algorithms may take into account factors such as signal strength, interference patterns, and environmental conditions to continuously refine the phase shift calculations and SLM configurations.

The method 700 may be applied in various scenarios, such as LiDAR systems for autonomous vehicles or free-space optical communication networks. In these applications, the ability to rapidly and precisely steer the beam while maintaining high beam quality may be beneficial for effective operation.

In aspects, the phased array antenna system may include additional components to further enhance its performance and capabilities. One such component that may be incorporated is a microlens array. The microlens array may be positioned to receive light modulated by the SLM 612. This configuration may allow for further manipulation and shaping of the light beam emitted or received by the antenna elements 615.

The microlens array may include a series of small lenses, each aligned with one or more antenna elements 615 or pixels 612(C) of the SLM 612. In cases, the microlens array may be used to collimate or focus the light from each antenna element 615 or SLM pixel 612(C) in grid 621, potentially improving the overall beam quality and reducing unwanted diffraction effects.

The inclusion of a microlens array may provide several potential benefits. For instance, it may help to increase the effective aperture of each antenna element 615, potentially improving the overall gain of the system. Additionally, the microlens array may assist in beam shaping, allowing for finer control over the beam pattern 103 produced by the phased array antenna system.

In implementations, the microlens array may be adjustable, allowing for dynamic control over its focusing properties. This adjustability may be achieved through various means, such as liquid lenses or mechanically deformable lenses. Such a configuration may provide additional flexibility in beam steering and shaping capabilities, potentially allowing the system to adapt to different operational requirements or environmental conditions.

The microlens array may be fabricated using various materials and techniques, depending on the specific requirements of the application. For example, in cases, the microlens array may be made from glass or plastic and may be produced using techniques such as photolithography, molding, or 3D printing.

In configurations, the microlens array may be integrated directly onto the surface of the SLM or may be a separate component positioned between the SLM and the intended direction of beam propagation. The specific placement and design of the microlens array may be improved based on factors such as the desired beam characteristics, the wavelength of operation, and the overall system architecture.

The decision to incorporate a microlens array may depend on factors such as the specific application requirements, cost considerations, and desired system complexity.

The phased array antenna system illustrated in FIGS. 6D and 6E may be adapted for use in a specific LiDAR application, such as an automotive collision avoidance system. The system may utilize the method outlined in FIG. 7 to dynamically adjust its beam configuration for improved performance in varying traffic conditions.

The phased array antenna system with SLM 612 may be designed to operate in the near-infrared wavelength range, typically around 905 nm or 1550 nm, which may be used for automotive LiDAR applications. In this configuration, the light source/detector 617 may be a pulsed laser diode capable of generating short, high-power optical pulses. The antenna elements 615 on the PIC 614 may be designed to efficiently couple with near-infrared radiation, potentially utilizing grating couplers or other suitable structures designed for this wavelength range.

The SLM may be adapted to work with near-infrared wavelengths, potentially utilizing liquid crystal on silicon (LCoS) technology or MEMS-based devices to achieve the desired phase modulation. Each SLM pixel may be designed to provide precise phase control over a range of at least 2π radians, allowing for full beam steering capabilities across the field of view desired for automotive applications.

In operation, the controller 616 may implement the method 700 to continuously update the beam configuration based on the vehicle's surroundings. For example, in step 702, the desired beam configuration may be determined based on inputs from the vehicle's navigation system, speed sensors, and other environmental sensors. The system may prioritize different scanning patterns depending on the driving scenario, such as a wide-angle, low-resolution scan for highway driving or a narrow, high-resolution scan for urban environments with numerous potential obstacles.

The phase shift calculations in step 703 may incorporate advanced signal processing algorithms to detect and track moving objects, such as other vehicles or pedestrians. The controller 616 may utilize techniques like frequency-modulated continuous wave (FMCW) LiDAR or time-of-flight measurements to determine the range, velocity, and direction of detected objects, potentially allowing the system to focus more resources on tracking objects that pose a higher collision risk.

In steps 704 and 705, the SLM configuration may be rapidly updated to implement these phase shifts, potentially allowing the system to perform multiple beam steering operations within a single frame of a typical automotive LiDAR system. This high update rate may enable the creation of a detailed, real-time 3D point cloud of the vehicle's surroundings, potentially improving the accuracy and responsiveness of the collision avoidance system.

The beam quality monitoring in step 706 may involve analyzing the returned LiDAR signals for various performance metrics, such as signal-to-noise ratio, angular resolution, and range accuracy. The system may dynamically adjust its transmission power and receiver sensitivity based on these measurements, potentially improving performance for different weather conditions or levels of ambient light interference.

In step 707, the phased array antenna system may implement a continuous improvement and adaptation process to maintain improved performance in dynamic environments. The controller 616 may utilize the feedback from the beam quality monitoring in step 706 to refine the beam configuration in real-time. This may involve adjusting the phase shifts applied by the SLM pixels 621 to compensate for changing conditions or to track moving targets more effectively.

The system may employ predictive algorithms to anticipate changes in the vehicle's surroundings. For example, the controller 616 may use data from the vehicle's navigation system and speed sensors to predict the future positions of other vehicles or obstacles. This predictive capability may allow the system to proactively adjust its beam configuration, potentially improving its responsiveness in rapidly changing traffic scenarios.

The controller 616 may also implement machine learning algorithms that continuously refine the system's performance based on accumulated data. These algorithms may analyze patterns in the received LiDAR signals and the corresponding environmental conditions to improve the beam forming strategies over time. This adaptive approach may enable the system to improve its detection and tracking capabilities in various driving scenarios, potentially enhancing the overall effectiveness of the collision avoidance system.

Step 707 may involve coordinating the phased array antenna system with other vehicle systems. For instance, the controller 616 may integrate data from cameras, radar sensors, or other LiDAR units to create a comprehensive situational awareness model. This multi-sensor fusion approach may allow for more robust object detection and classification, potentially improving the system's ability to identify and respond to potential collision risks.

The dynamic beam configuration process in step 707 may also include adaptive power management strategies. The controller 616 may adjust the transmission power and receiver sensitivity based on the current driving environment and detected objects. For example, the system may increase its power and sensitivity when operating in adverse weather conditions or when potential obstacles are detected at greater distances. Conversely, it may reduce power consumption in less demanding scenarios, potentially improving the system's energy efficiency.

While the foregoing is directed to example embodiments described herein, other and further example embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed example embodiments, are example embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A phased array antenna system, comprising:
a substrate;
an energy source or an energy detector; and
a plurality of antenna elements arranged in a spiral pattern on the substrate and coupled to the energy source configured to transmit energy from the antenna elements or coupled to the energy detector configured to receive energy via the antenna elements, the spiral pattern based on parameters defining physical placement of the antenna elements relative to one another on the spiral pattern and relative to a center of the spiral pattern to minimize sidelobes of an interference pattern produced the transmitted energy or received energy via the antenna elements.

2. The phased array antenna system of claim 1,
wherein the parameters defining the physical placement of the antenna elements may comprise a spiral power parameter defining how tightly the spiral is wound, an angular step parameter defining an angle between consecutive antenna elements, and a spiral start parameter defining a starting point of the spiral.

3. The phased array antenna system of claim 2,
wherein the spiral power parameter, the angular step parameter and the spiral start parameter are set in relation to one another to produce the spiral pattern that minimizes the sidelobes of the interference pattern.

4. The phased array antenna system of claim 1, further comprising: waveguides extending from the antenna elements, the waveguides coupled to the energy source or the energy detector, the waveguides extending from the antenna elements at an angle perpendicular to the substrate.

5. The phased array antenna system of claim 1, wherein the antenna elements are at least one of optical emitters, acoustic emitters, radio frequency emitters, optical receivers, acoustic receivers, radio frequency receivers.

6. The phased array antenna system of claim 1, further comprising: a spiral waveguide extending from the energy source or the energy detector and evanescently coupled to the antenna elements.

7. The phased array antenna system of claim 1, further comprising: radial waveguides extending from the antenna elements, the radial waveguides coupled to the energy source or the energy detector.

8. The phased array antenna system of claim 1, wherein setting the parameters comprises a defined search space for the parameters, and iterative adjustment of the parameter to improve minimization of the sidelobes.

9. A phased array antenna system for an optical array, comprising:
a substrate;
a light source or a light detector;
a plurality of optical antenna elements arranged in a spiral pattern on the substrate and coupled to the light source configured to transmit light from the antenna elements or coupled to the light detector configured to receive light via the antenna elements, the spiral pattern based on parameters defining physical placement of the antenna elements relative to one another on the spiral pattern and relative to a center of the spiral pattern to minimize sidelobes of an interference pattern produced the transmitted light or received light via the antenna elements; and
a spatial light modulator positioned to receive and modulate light emitted from the plurality of optical antenna elements or received by the phased array antenna system to perform beam steering.

10. The phased array antenna system of claim 9,
wherein the parameters defining the physical placement of the optical antenna elements may comprise a spiral power parameter defining how tightly the spiral is wound, an angular step parameter defining an angle between consecutive optical antenna elements, and a spiral start parameter defining a starting point of the spiral.

11. The phased array antenna system of claim 10,
wherein the spiral power parameter, the angular step parameter and the spiral start parameter are set in relation to one another to produce the spiral pattern that minimizes the sidelobes of the interference pattern.

12. The phased array antenna system of claim 9, further comprising: waveguides extending from the antenna elements, the waveguides coupled to the light source or the light detector, the waveguides extending from the antenna elements at an angle perpendicular to the substrate.

13. The phased array antenna system of claim 9, further comprising a spiral waveguide extending from the light source or the light detector and evanescently coupled to the optical antenna elements.

14. The phased array antenna system of claim 9, further comprising radial waveguides extending from the antenna elements, the radial waveguides coupled to the light source or the light detector.

15. The phased array antenna system of claim 9, wherein setting the parameters comprises defining a search space for the parameters, and iterative adjustment of the parameters to improve minimization of the sidelobes.

16. The phased array antenna system of claim 9, further comprising a controller configured to control the spatial light modulator to adjust phase shifts of light emitted from the optical antenna elements.

17. The phased array antenna system of claim 16, wherein the controller is configured to determine the phase shifts for each of the optical antenna elements based on a desired beam direction.

18. The phased array antenna system of claim 16, wherein the controller is configured to map each of the optical antenna elements to corresponding pixels of the spatial light modulator.

19. The phased array antenna system of claim 16, wherein the controller is configured to dynamically update the spatial light modulator configuration to change a desired beam direction for scanning or tracking applications.

20. The phased array antenna system of claim 16, wherein the controller is configured to:
monitor beam quality of a formed beam, comprising assessing sidelobe suppression and main lobe direction;
adjust the spatial light modulator configuration based on the monitored beam quality; and
compensate for environmental factors by fine-tuning the spatial light modulator configuration.

21. The phased array antenna system of claim 9, further comprising a microlens array positioned to receive light modulated by the spatial light modulator.

22. The phased array antenna system of claim 9, wherein the spatial light modulator comprises a transmissive liquid crystal on silicon device.
